(19) United States
(12) Patent Application Publication
(10) Pub. No.: US 2026/0230285 A1
(43) Pub. Date: Aug. 6, 2026

(54) FEEDBACK DEFERRAL IN FULL-DUPLEX CONFIGURATIONS

(71) Applicant: QUALCOMM Incorporated, San Diego, CA (US)

(72) Inventors: Mohammed JABI, San Diego, CA (US); Abdelrahman Mohamed IBRAHIM, San Diego, CA (US); Muhammad Sayed Khairy ABDELGHAFFAR, San Jose, CA (US)

(21) Appl. No.: 19/047,262

(22) Filed: Feb. 6, 2025

(51) Int. Cl. H04L 5/00; H04L 5/14; H04W 56/00; H04W 72/20; H04W 72/51

(52) U.S. Cl. CPC H04L 5/0078; H04L 5/14; H04W 56/0015; H04W 72/20; H04W 72/51

(57) ABSTRACT

Various aspects of the present disclosure generally relate to wireless communication. In some aspects, a user equipment (UE) may receive, from a network node, a subband full-duplex (SBFD) configuration that configures one or more SBFD time intervals and one or more non-SBFD time intervals. The UE may receive, from the network node, a downlink message in accordance with the SBFD configuration. The UE may transmit, to the network node in accordance with the downlink message, an uplink message during a valid time interval that may be based on a valid time interval type and a configuration type that enables one or more uplink transmissions during at least one of the one or more SBFD time intervals or the one or more non-SBFD time intervals. Numerous other aspects are described.

### INTRODUCTION

Aspects of the present disclosure generally relate to wireless communication and specifically relate to techniques, apparatuses, and methods associated with full-duplex communication.

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples of wireless communications, a network node and a user equipment (UE) may communicate downlink transmissions and uplink transmissions. For example, the network node may transmit, and the UE may receive, a semi-persistent scheduling (SPS) physical downlink shared channel (PDSCH) message. For example, SPS is a mechanism that pre-allocates radio resources for periodic transmissions, reducing control signaling overhead as compared to dynamic scheduling. In some examples, the network node may configure SPS through radio resource control (RRC) signaling, where the network node assigns SPS parameters such as a periodicity, a number of hybrid automatic repeat request (HARQ) processes, a modulation and coding scheme (MCS) table, and an identity of physical uplink control channel (PUCCH) resources. In accordance with receiving the SPS-PDSCH message, the UE may process the data and respond with an SPS-HARQ message, which includes an acknowledgment (ACK) if the data is correctly decoded or a negative acknowledgment (NACK) if errors are detected. The UE may transmit the SPS-HARQ message via a physical uplink control channel (PUCCH).

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, a subband full-duplex (SBFD) configuration that configures one or more SBFD time intervals and one or more non-SBFD time intervals. The one or more processors may be configured to receive, from the network node, a downlink message in accordance with the SBFD configuration. The one or more processors may be configured to transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to a network node for wireless communication. The network node may include one or more memories and one or more processors coupled to the one or more memories. The one or more processors may be configured to send an SBFD configuration that configures one or more SBFD time intervals and one or more non-SBFD time intervals. The one or more processors may be configured to send a downlink message in accordance with the SBFD configuration. The one or more processors may be configured to obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to a method of wireless communication performed by a UE. The method may include receiving, from a network node, an SBFD configuration that configures one or more SBFD time intervals and one or more non-SBFD time intervals. The method may include receiving, from the network node, a downlink message in accordance with the SBFD configuration. The method may include transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to a method of wireless communication performed by a network node. The method may include sending an SBFD configuration that configures one or more SBFD time intervals and one or more non-SBFD time intervals. The method may include sending a downlink message in accordance with the SBFD configuration. The method may include obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to a non-transitory computer-readable medium that stores a set of instructions for wireless communication by a UE. The set of instructions, when executed by one or more processors of the UE, may cause the UE to receive, from a network node, an SBFD configuration that configures one or more SBFD time intervals and one or more non-SBFD time intervals. The set of instructions, when executed by one or more processors of the UE, may cause the UE to receive, from the network node, a downlink message in accordance with the SBFD configuration. The set of instructions, when executed by one or more processors of the UE, may cause the UE to transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to a non-transitory computer-readable medium that stores a set of instructions for wireless communication by a network node. The set of instructions, when executed by one or more processors of the network node, may cause the network node to send an SBFD configuration that configures one or more SBFD time intervals and one or more non-SBFD time intervals. The set of instructions, when executed by one or more processors of the network node, may cause the network node to send a downlink message in accordance with the SBFD configuration. The set of instructions, when executed by one or more processors of the network node, may cause the network node to obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to an apparatus for wireless communication. The apparatus may include means for receiving, from a network node, an SBFD configuration that configures one or more SBFD time intervals and one or more non-SBFD time intervals. The apparatus may include means for receiving, from the network node, a downlink message in accordance with the SBFD configuration. The apparatus may include means for transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Some aspects described herein relate to an apparatus for wireless communication. The apparatus may include means for sending an SBFD configuration that configures one or more SBFD time intervals and one or more non-SBFD time intervals. The apparatus may include means for sending a downlink message in accordance with the SBFD configuration. The apparatus may include means for obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a hybrid automatic repeat request feedback deferral.

FIG. 4 is a diagram illustrating an example of subband full duplex (SBFD) configuration.

FIG. 5 is a diagram illustrating an example of multiple types of configurations for SBFD operation.

FIGS. 6A through 6D are diagrams illustrating examples associated with uplink message deferral in accordance with an SBFD configuration.

FIGS. 7A and 7B are diagrams illustrating examples associated with uplink message deferral in accordance with a first configuration for SBFD operations.

FIGS. 8A through 8C are diagrams illustrating examples associated with uplink message deferral in accordance with a second configuration for SBFD operations.

FIG. 9 is a diagram illustrating an example associated with signaling that enables feedback deferral in full-duplex configuration.

FIG. 10 is a diagram illustrating an example process performed, for example, at a user equipment (UE) or an apparatus of a UE.

FIG. 11 is a diagram illustrating an example process performed, for example, at a network node or an apparatus of a network node.

FIG. 12 is a diagram of an example apparatus for wireless communication.

FIG. 13 is a diagram illustrating an example of a hardware implementation for an apparatus employing a processing system.

FIG. 14 is a diagram illustrating an example of an implementation of code and circuitry for an apparatus.

FIG. 15 is a diagram of an example apparatus for wireless communication.

FIG. 16 is a diagram illustrating an example of a hardware implementation for an apparatus employing a processing system.

FIG. 17 is a diagram illustrating an example of an implementation of code and circuitry for an apparatus.

### DETAILED DESCRIPTION

In some examples of wireless communications, a network node and a user equipment (UE) may communicate downlink transmissions and uplink transmissions. For example, the network node may transmit, and the UE may receive, a semi-persistent scheduling (SPS) physical downlink shared channel (PDSCH) message to the UE. For example, SPS is a mechanism that pre-allocates radio resources for periodic transmissions, reducing control signaling overhead compared to dynamic scheduling. In some examples, the network node may configure SPS through radio resource control (RRC) signaling, where the network node assigns SPS parameters such as a periodicity, a number of hybrid automatic repeat request (HARQ) processes, a modulation and coding scheme (MCS) table, and an identity of physical uplink control channel (PUCCH) resources. In accordance with receiving the SPS-PDSCH message, the UE may process the data and respond with an SPS-HARQ message, which includes an acknowledgment (ACK) if the data is correctly decoded or a negative acknowledgment (NACK) if errors are detected. The UE may transmit the SPS-HARQ message via a physical uplink control channel (PUCCH). In some examples, SPS-HARQ messages may be part of a HARQ mechanism. For example, the network node may pre-configure resource for SPS-HARQ messages in accordance with SPS. In some other examples of the HARQ mechanism, the network node may dynamically schedule the UE with resources for a HARQ message (e.g., a non-SPS HARQ message that is scheduled dynamically via medium access control (MAC) signaling or downlink control information (DCI) signaling).

In some examples, the network node and the UE may communicate the uplink and downlink messages in accordance with a subband full-duplex (SBFD) configuration. For example, the SBFD configuration may enable the network node to concurrently transmit downlink messages and receive uplink messages within the same time slot, but in different frequency subbands. The SBFD configuration may include one or more SBFD time intervals and one or more non-SBFD time intervals (e.g., one or more downlink time intervals, uplink time intervals, or flexible time intervals). For example, SBFD time intervals may be associated with a frequency band that includes an uplink frequency subband allocated for UE transmissions and includes one or more downlink frequency subbands allocated for network transmissions. The non-SBFD time intervals may include time intervals where the frequency band is associated with either downlink or uplink. For example, “downlink time intervals” may refer to time intervals where the frequency band is configured with downlink resources to enable downlink transmissions, and “uplink time intervals” may refer to time intervals where the frequency band is configured with uplink resources to enable uplink transmissions. Additionally, flexible time intervals may allow dynamic switching between uplink and downlink transmission modes based on network scheduling decisions (e.g., adapting to traffic demand and interference conditions). For example, the network node may dynamically configure a flexible time interval to be either an uplink time interval or a downlink time interval. In some examples, the term “time interval” as used herein may refer to one or more symbols, one or more mini-slots, one or more sub-slots, or one or more slots.

In some examples, the SBFD configuration may indicate to the UE a first configuration type or a second configuration type for SBFD operations. For example, the first configuration type may enable the UE to transmit uplink transmissions during one of SBFD time intervals or non-SBFD time intervals. The second configuration type may enable the UE to transmit uplink transmissions during both SBFD time intervals and non-SBFD time intervals.

In some examples, the UE may identify a triggering condition to defer a transmission of an SPS-HARQ message from a first time interval to a second time interval (e.g., apply a HARQ deferral). In some examples, the triggering condition may be based on the SPS-HARQ message overlapping with a downlink time interval. In some examples the triggering condition may be based on the SPS-HARQ message overlapping in time with a synchronization signal block (SSB) transmission. For instance, an SSB transmission may be a set of signals that the network node may transmit, and the UE may receive, associated with UE synchronization to the network node (e.g., to synchronize with the network node in the spatial, frequency, and time domain). In some examples, the triggering condition may be based on the SPS-HARQ message overlapping in time with a control resource set (CORESET) used for a Type-0 common search space (CSS) (e.g., a Type-0-CSS CORESET). For instance, a Type-0-CSS CORESET may be associated with initial access and system information acquisition. In some examples, the Type-0-CSS CORESET may include a set of frequency and time-domain resources within which the network node may schedule DCI (e.g., for broadcast messages, such as RAR (random access response) and system information). Accordingly, if the UE identifies a triggering condition, the UE may defer the SPS-HARQ message to a later time intervals.

In some cases, however, the triggering condition associated with deferring an SPS-HARQ message may be associated with time division duplex (TDD) time intervals (e.g., associated with uplink and downlink time intervals), but independent of SBFD time intervals. Accordingly, the UE may be unaware of triggering conditions for SPS-HARQ deferral if the SPS-HARQ message is scheduled during an SBFD time interval. Further, if the UE were to defer an SPS-HARQ message, the UE may be unaware of a deferral procedure to determine a next available time interval in SBFD configurations associated with the first configuration type or the second configuration type. Therefore, deferring SPS-HARQ messages during time intervals of an SBFD configuration may result in miscommunication between the network node and the UE, which may result in dropped wireless messages or message collisions and inefficient use of wireless resources.

Various aspects relate generally to SPS-HARQ deferral in accordance with an SBFD configuration. For example, the aspects herein may describe how the UE identifies whether an SPS-HARQ message is scheduled during a valid time interval. A valid time interval, may be a time interval where the UE is allowed to or enabled to transmit a feedback communication (e.g., an SPS-HARQ message) while operating in an SBFD configuration (e.g., a configuration where both one or more SBFD time intervals and one or more non-SBFD time intervals are configured). Accordingly, if the UE determines that the SPS-HARQ message is scheduled during a time interval that is not valid, the aspects herein may enable the UE to identify a next available valid time interval and defer transmission of the SPS-HARQ message to the identified valid time interval.

Some aspects relate to the UE identifying a valid time interval for transmission of an SPS-HARQ message during the SBFD configuration. In some examples, the valid time interval may be based on identifying a valid time interval type and the configuration type associated with the SBFD operations. In some examples, the network node may transmit, and the UE may receive, control signaling (e.g., RRC signaling) that indicates whether the valid time interval type for an SPS-HARQ message is of an SBFD-type (e.g., transmit during an SBFD time interval) or a non-SBFD-type (e.g., transmit during an uplink or flexible time interval). In some examples, the network node may transmit, and the UE may receive, control information (e.g., an activating DCI) that schedules a one or more SPS-PDSCH messages and one or more SPS-HARQ messages. In some examples, the valid time interval type may be the same as a time interval type associated with an initial SPS-HARQ message of the one or more of SPS-HARQ messages. For example, the initial SPS-HARQ message may be the first SPS-HARQ message in time of the one or more SPS-HARQ messages that is scheduled for transmission by the control information. In some examples, the valid time interval type may be equal to (e.g., the same as) a time interval type associated with an initial SPS-PDSCH message of the one or more SPS-PDSCH messages. For example, the initial SPS-PDSCH message may be the first SPS-PDSCH message in time of the one or more SPS-PDSCH messages that is scheduled for transmission by the control information.

Accordingly, the UE may use the determined valid time interval type in combination with the configuration type associated with the SBFD operation to determine a valid time interval for the SPS-HARQ message. For example, if the UE operates in accordance with the first configuration type (e.g., enabling the UE to transmit uplink transmissions during one of SBFD time intervals or non-SBFD time intervals) and the valid time interval type is the SBFD-type, then the valid time interval is a next available SBFD time interval after an associated SPS-PDSCH message. If the UE operates in accordance with the first configuration type and the valid time interval type is the non-SBFD-type, then the valid time interval is a next available uplink or flexible time interval after the associated SPS-PDSCH message. If the UE operates in accordance with the second configuration type (e.g., enabling the UE to transmit uplink transmissions during both SBFD time intervals and non-SBFD time intervals), then the valid time interval is a next available SBFD, uplink, or a flexible time interval after the associated SPS-PDSCH message.

Additionally, for a time interval to be the valid time interval, one or more first symbols of the SPS-HARQ message may be different than one or more second symbols associated with an SSB transmission or a Type-0-CSS CORESET. In other words, a time interval may not include one or more symbols of an SSB or Type-0-CSS CORESET that overlap with the SPS-HARQ message to be considered a valid time interval.

Accordingly, the UE may transmit the SPS-HARQ message during the valid time interval. If the SPS-HARQ message is not originally scheduled for the identified valid time interval, then the UE may apply a HARQ deferral to postpone transmission of the SPS-HARQ message for transmission during the valid time interval.

Particular aspects of the subject matter described in this disclosure can be implemented to enable HARQ deferral operations during SBFD configurations. For example, by identifying a valid interval type, both the UE and the network node may be aware of whether an SPS-HARQ transmission may occur during an SBFD or non-SBFD time interval, which may increase communication reliability between the network node and UE. Additionally, examples where the network node indicates the valid interval type via control signaling may increase network flexibility in selecting intervals for SPS-HARQ transmissions, which may enable the network node to dynamically adapt HARQ procedures based on changes to the network environment. Additionally, examples where the UE identifies the valid interval type via the activating DCI may enable the UE to identify the valid interval type for multiple SPS-HARQ messages, which may reduce signaling overhead. Further, transmitting multiple SPS-HARQ messages using a same type of time interval may enable the UE to transmit in accordance with a same set of power control parameters, reducing complexity associated with transmitting multiple SPS-HARQ transmissions. Additionally, the subject matter described in this disclosure can be implemented to enable HARQ deferral according to both the first configuration type and the second configuration type associated with SBFD operations, which may increase communication reliability between the network node and UE. Additionally, the subject matter described in this disclosure can be implemented to reduce collisions between SPS-HARQ transmissions and downlink transmissions (e.g., SSB transmissions and transmissions associated with a Type-0-CSS CORESET).

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

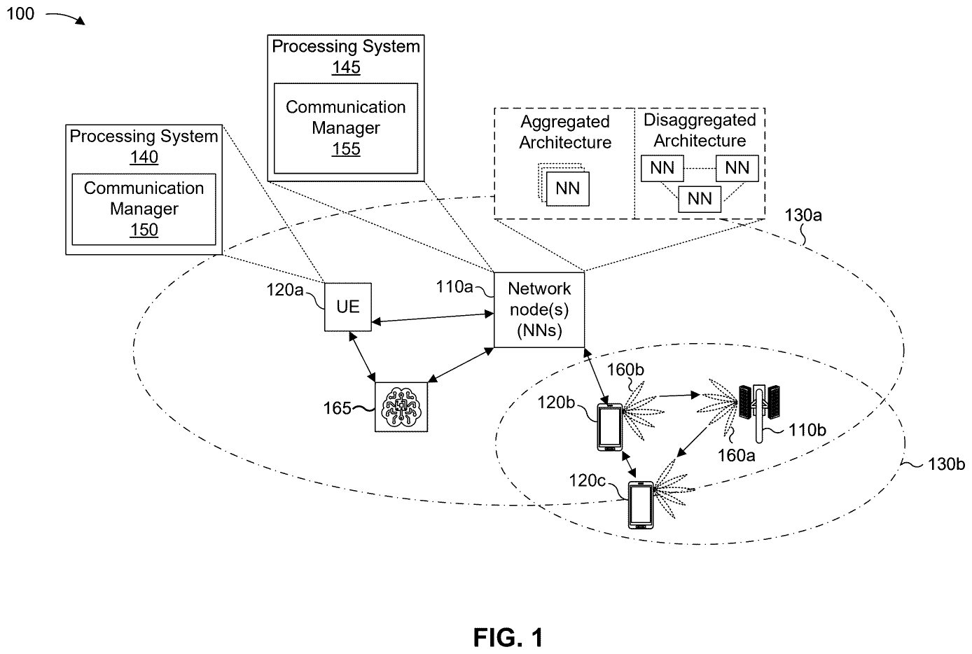

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR 4a or FR4-1 (52.6 GHz through 71 GHz), FR4 (52.6 GHz through 114.25 GHz), and FR 5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, an SBFD configuration that configures one or more SBFD time intervals and one or more non-SBFD time intervals; receive, from the network node, a downlink message in accordance with the SBFD configuration; and transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. Additionally, or alternatively, the communication manager 150 may perform one or more other operations described herein.

In some aspects, the network node 110 may include a communication manager 155. As described in more detail elsewhere herein, the communication manager 155 may send an SBFD configuration that configures one or more SBFD time intervals and one or more non-SBFD time intervals; send a downlink message in accordance with the SBFD configuration; and obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. Additionally, or alternatively, the communication manager 155 may perform one or more other operations described herein.

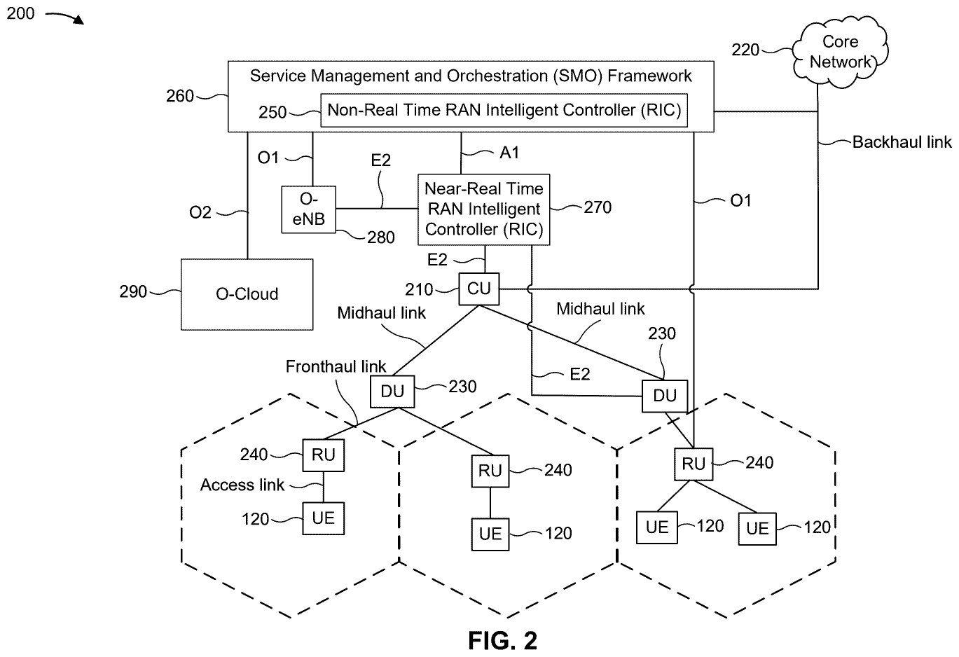

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The

Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

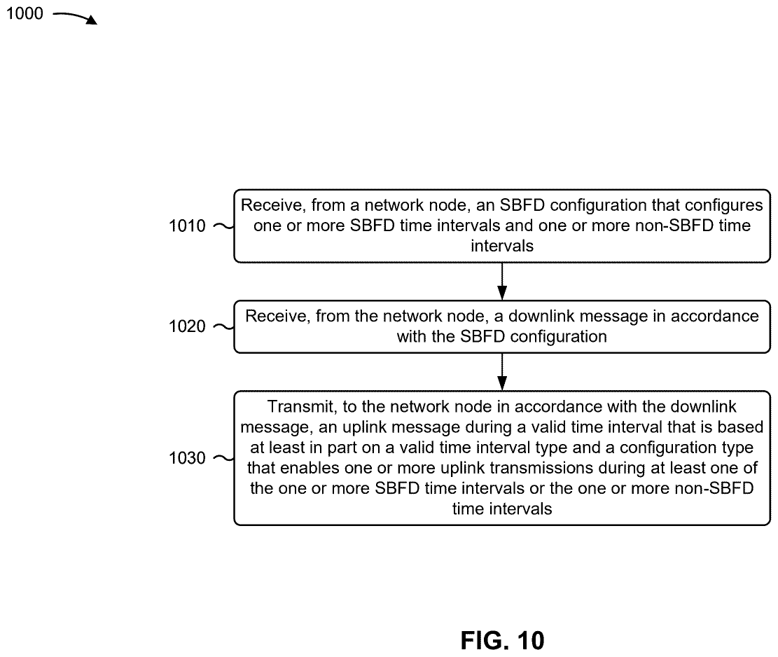

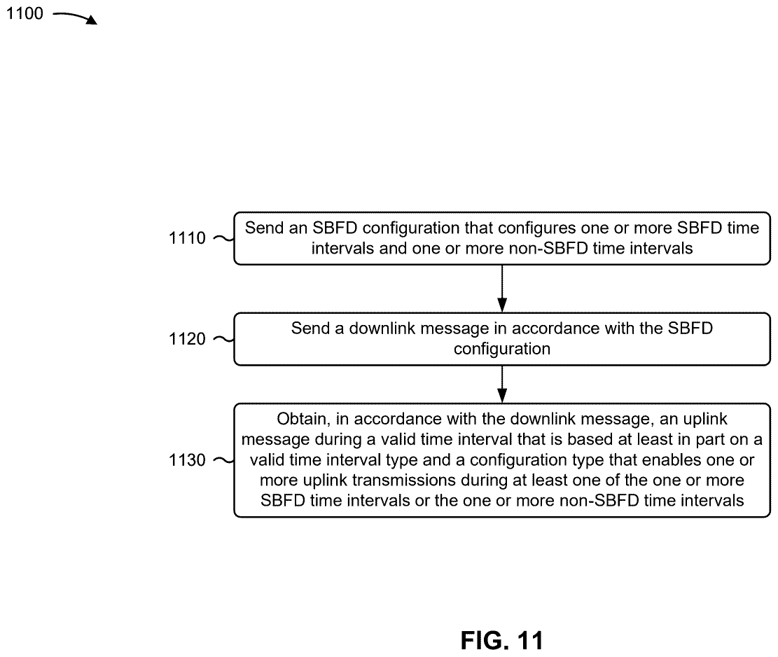

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with feedback deferral in full-duplex configurations, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, or interpreting the instructions, among other examples.

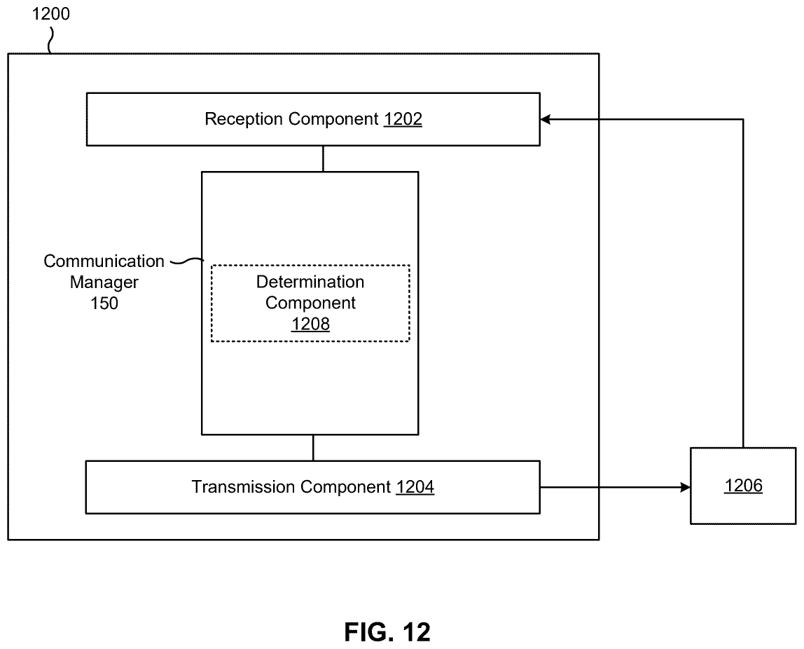

In some aspects, a UE includes means for receiving, from a network node, an SBFD configuration that configures one or more SBFD time intervals and one or more non-SBFD time intervals; means for receiving, from the network node, a downlink message in accordance with the SBFD configuration; or means for transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

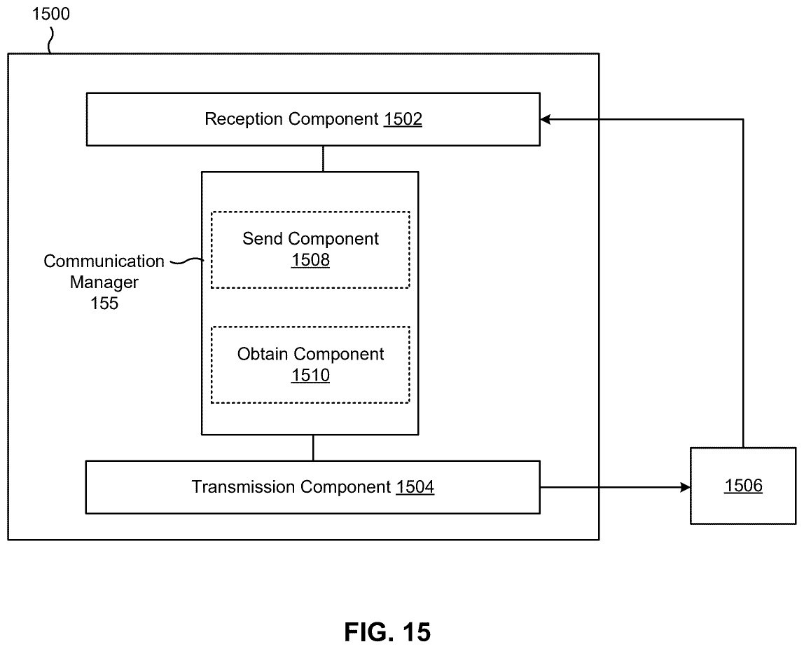

In some aspects, a network node includes means for sending an SBFD configuration that configures one or more SBFD time intervals and one or more non-SBFD time intervals; means for sending a downlink message in accordance with the SBFD configuration; or means for obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

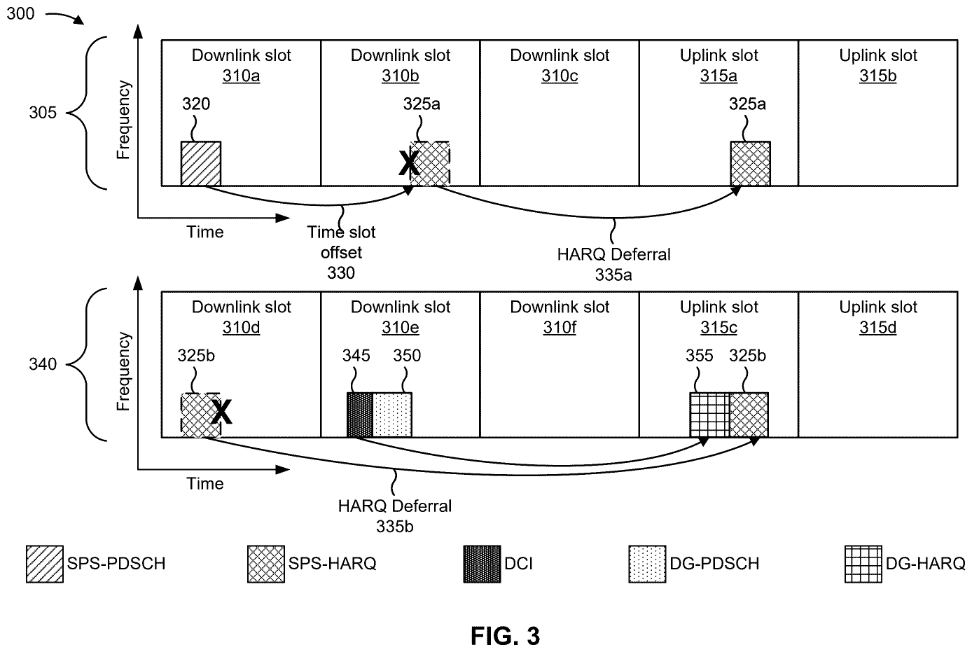

FIG. 3 is a diagram illustrating an example 300 of HARQ feedback deferral. In some instances, example 300 may implement or be implemented by one or more aspects of FIGS. 1 and 2. For instance, FIG. 3 may illustrate wireless communications between the network node 110 and the UE 120.

As shown, FIG. 3 may include a first communication timeline 305 and a second communication timeline 340, associated with a TDD configuration. In some aspects, a TDD configuration may indicate a first slot format pattern (sometimes called a TDD pattern) associated with a half-duplex mode. The first slot format pattern may include a number of downlink slots 310 (e.g., downlink slots 310a, 310b, and 310b, as shown in the first communication timeline 305, and downlink slots 310d, 310e, and 310f, as shown in the second communication timeline 340), include a number of flexible slots (not shown), or include a number of uplink slots (e.g., uplink slots 315a and 315b, as shown in the first communication timeline 305, and uplink slots 315c and 315d, as shown in the second communication timeline 340). In some examples, the first slot format pattern may repeat over time. In some aspects, the network node 110 may indicate the first slot format pattern to the UE 120 using one or more slot format indicators. A slot format indicator, for a slot, may indicate whether that slot is an uplink slot, a downlink slot, or a flexible slot, among other examples. The network node 110 may transmit, and the UE 120 may receive, one or more slot format indications via one or more of a radio resource control (RRC) message, a medium access control (MAC) control element (CE) (MAC-CE), or downlink control information (DCI).

With reference to the first communication timeline 305, the network node 110 and the UE 120 may communicate one or more downlink and uplink messages. For example, with reference to the first communication timeline 305, the network node 110 may transmit, and the UE 120 may receive, a semi-persistent scheduling (SPS) for a physical downlink shared channel (PDSCH) (e.g., an SPS-PDSCH 320). In some examples, the SPS-PDSCH 320 is associated with a mechanism that enables periodic or persistent allocation of downlink resources to the UE 120. Such allocation of downlink resources may reduce control signaling overhead. In some examples of downlink SPS, the network node 110 may pre-configure the UE 120 with SPS parameters via RRC signaling, and once activated, the UE 120 may monitor for downlink data on the allocated resources at predefined intervals. In some examples, the network node 110 can dynamically release or modify the SPS configuration to adapt to changing traffic conditions. Therefore, the SPS-PDSCH 320 may be a downlink data message associated with an SPS configuration.

In accordance with receiving the SPS-PDSCH 320, the UE 120 may transmit, and the network node 110 may receive, an SPS-HARQ 325a. In some examples, the SPS-HARQ 325a may be associated with a retransmission mechanism designed to support SPS. For example, the SPS configuration may pre-allocate resources for periodic transmissions, and HARQ operates alongside the SPS allocation to handle packet errors and retransmissions. If the UE 120 successfully receives and decodes an SPS downlink message (e.g., the SPS-PDSCH 320), then the UE 120 may transmit an SPS-HARQ message that includes a HARQ ACK indication. If the UE 120 is unable to receive or decode an SPS downlink message, then the UE 120 may transmit an SPS-HARQ message that includes a HARQ NACK indication.

In some examples, a slot in which the UE 120 transmits the SPS-HARQ 325a may be based on a time slot offset 330 (e.g., K1). For example, the SPS configuration that configures transmission of the SPS-PDSCH 320 may indicate a value K1 that may indicate the time slot offset 330 that may be relative to the downlink slot 310a during which the SPS-PDSCH 320 is transmitted. For instance, with reference to the first communication timeline 305, K1=1, such that the UE 120 is indicated to transmit the HARQ-PUSCH 325a one slot after the SPS-PDSCH 320. In some examples, the UE 120 may use a HARQ deferral (e.g., a HARQ deferral 335a) if the UE 120 is unable to transmit a HARQ-PDSCH 325 during a slot indicated by the value of K1 (e.g., the slot is invalid). In some examples, the HARQ deferral 335a may be triggered if the SPS-HARQ 325a at least partially overlaps with one or more semi-static downlink symbols (e.g., overlaps with a symbol indicated as downlink by tdd-UL-DL-ConfigurationCommon via an RRC configuration), one or more SSB symbols (e.g., overlaps with a symbol indicated for an SS/PBCH block by ssb-PositionsInBurst via an RRC configuration), or a CORESET for Type-0 PDCCH CSS (e.g., symbols belonging to or associated with CORESET with a Type-0-PDCCH CSS set).

In some examples, SPS-HARQ deferral may be configured per SPS configuration (e.g., the network node 110 indicates an sps-HARQ-Deferral parameter per SPS configuration). In some examples, an sps-HARQ-Deferral parameter may indicate a permissible (e.g., maximum) time, after which the UE 120 may stop attempting to find one or more available PUCCH resources for a deferred SPS-HARQ transmission. For instance, the value range for a given sps-HARQ-Deferral parameter may be set from a value range of {0 to 31} slots or sub-slots. Additionally, the SPS-HARQ deferral configuration may support concurrent L1 priority schemes. For example, the UE 120 may be concurrently configured with a high priority (HP) SPS configuration (e.g., latency sensitive data traffic) and a low priority (LP) SPS configuration (e.g., non-latency sensitive data traffic). Therefore, the UE 120 may have two parallel SPS-HARQ deferral procedures (e.g., a first SPS-HARQ deferral procedure for HP-SPS and a second SPS-HARQ deferral procedure for LP-SPS). In some examples, an SPS-HARQ deferral may not be triggered if an SPS-HARQ transmission overlaps with one or more flexible symbols that have been converted or turned into one or more downlink symbols.

With reference to the first communication timeline 305, the UE 120 may perform HARQ deferral 335a for the SPS-HARQ 325a in accordance with the SPS-HARQ 325a overlapping with one or downlink symbols (e.g., in the downlink slot 310b). Therefore, in accordance with the SPS-HARQ deferral configuration, the HARQ deferral 335a may defer the SPS-HARQ 325a to a next available uplink or flexible slot, where the one or more symbols of the HARQ deferral 335a do not overlap with SSB symbols or a CORESET for Type-0 PDCCH CSS (e.g., the uplink slot 315a). Accordingly, the UE 120 may transmit, and the network node 110 may receive, the SPS-HARQ 325a during the uplink slot 315a.

With reference to the second communication timeline 340, the network node 110 may transmit, and the UE 120 may receive, a DCI 345 that schedules a dynamic grant (DG) PDSCH transmission (e.g., a DG-PDSCH 350). For example, the DG-PDSCH 350 may refer to a dynamically scheduled downlink transmission where the network node 110 assigns resources to the UE 120 on a per-transmission basis. For example, the DG-PDSCH 350 may be associated with the DCI 345 messages sent via a PDCCH to dynamically allocate one or more of frequency, time, or modulation parameters for the DG-PDSCH 350. Additionally, the DCI 345 may schedule a DG-HARQ transmission (e.g., a DG-HARQ 355). For example, the DG-HARQ 355 may refer to a dynamically scheduled downlink transmission where the DCI 345 (e.g., sent via the PDCCH) may dynamically allocate one or more of frequency, time, or modulation parameters for the DG-HARQ 355.

With reference to the second communication timeline 340, the UE 120 may multiplex an SPS-HARQ 325b with another PUCCH or PUSCH in a same slot. For instance, the UE 120 may trigger a HARQ deferral 335b for the SPS-HARQ 325b based on the SPS-HARQ 325b overlapping with one or downlink symbols (e.g., in the downlink slot 310d). In some examples, the HARQ deferral 335b may defer the SPS-HARQ 325b to a same slot as the DG-PDSCH 350. Accordingly, the UE 120 may multiplex the DG-PDSCH 350 and the SPS-HARQ 325b. For example, “multiplexing” may refer to the UE 120 combining multiple data transmissions (e.g., the DG-PDSCH 350 and the SPS-HARQ 325b) onto the same uplink resources to improve spectral efficiency and reduce signaling overhead. In some examples, before multiplexing, the DG-PDSCH 350 and the SPS-HARQ 325b may be associated with different HARQ codebooks. For example, a HARQ codebook may indicate how an associated HARQ feedback may be structured and transmitted by the UE 120 to the network node 110. A HARQ codebook may specify the mapping of ACK or NACK responses for multiple downlink transmissions, considering factors such as scheduling type (dynamic or semi-persistent), multiple HARQ processes, or carrier aggregation. Accordingly, the HARQ codebook of the SPS-HARQ 325b may be updated. In some examples, the UE 120 may append a deferred SPS-HARQ codebook to the updated HARQ codebook (e.g., the HARQ codebook for SPS-HARQ 325b may be appended to the HARQ codebook for the DG-HARQ 355.

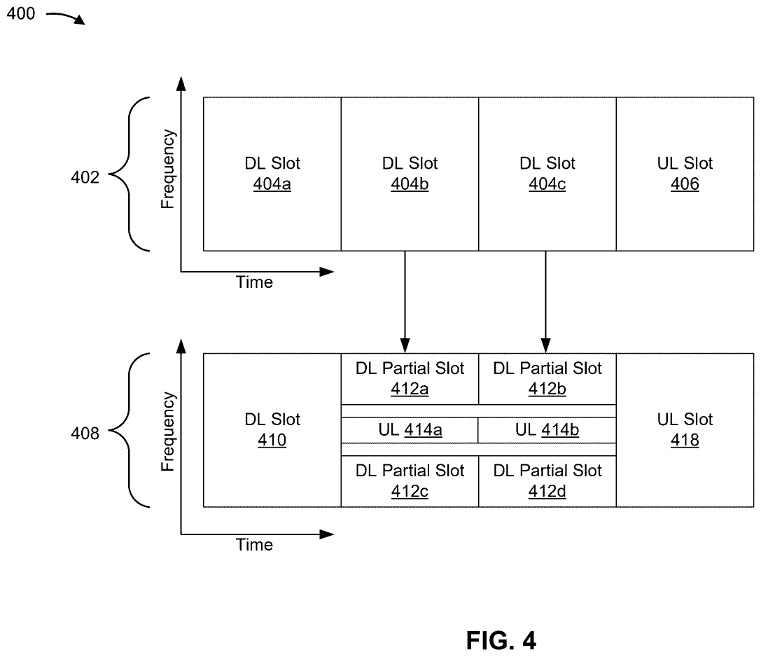

FIG. 4 is a diagram illustrating an example 400 of subband full duplex (SBFD) configuration. As shown in FIG. 4, example 400 includes a TDD configuration 402. In some aspects, the TDD configuration 402 may indicate a first slot format pattern (sometimes called a TDD pattern) associated with a half-duplex mode or a full-duplex mode. The first slot format pattern may include a quantity of downlink slots (e.g., three downlink slots 404a, 404b, and 404c, as shown), a quantity of flexible slots (not shown), or a quantity of uplink slots (e.g., one uplink slot 406, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as a radio resource control (RRC) message, a medium access control (MAC) control element (CE) (MAC-CE), or downlink control information (DCI)) a UE 120 to switch from the TDD configuration 402 to an SBFD configuration 408. As an alternative, the UE 120 may indicate to the network node 110 that the UE 120 is switching from the TDD configuration 402 to the SBFD configuration 408. The SBFD configuration 408 may indicate a second slot format pattern that repeats over time, similar to the first slot format pattern. In any of the aspects described above, the UE 120 may switch from the TDD configuration 402 to the SBFD configuration 408 during a time period (e.g., a quantity of symbols or an amount of time (e.g., in ms)) based at least in part on an indication received from the network node 110 (e.g., before switching back to the TDD configuration 402). During that time period, the UE 120 may communicate using the second slot format pattern, and then may revert to using the first slot format pattern after the end of the time period. The time period may be indicated by the network node 110 (e.g., in the instruction to switch from the TDD configuration 402 to the SBFD configuration 408, as described above) or based at least in part on a programmed or otherwise preconfigured rule. For example, the rule may be based at least in part on a table (e.g., defined in 3GPP specifications or another wireless communication standard) that associates different sub-carrier spacings (SCSs) or numerologies (e.g., represented by μand associated with corresponding SCSs) with corresponding time periods for switching configurations.

In example 400, the second slot format pattern includes two SBFD slots in place of what were downlink slots in the first slot format pattern. In example 400, each SBFD slot includes a partial slot (e.g., a portion or subband of a frequency allocated for use by the network node 110 and the UE 120) for downlink (e.g., partial slots 412a, 412b, 412c, and 412d, as shown) and a partial slot for uplink (e.g., partial slots 414a and 414b, as shown). Accordingly, the UE 120 may operate using the second slot format pattern to transmit an uplink communication in an earlier slot (e.g., the second slot in sequence, shown as partial uplink slot 414a) as compared to using the first slot format pattern (e.g., the fourth slot in sequence, shown as uplink slot 406). Other examples may include additional or alternative changes. For example, the SBFD configuration 408 may indicate an SBFD slot in place of what was an uplink slot in the TDD configuration 402 (e.g., uplink slot 406). In another example, the SBFD configuration 408 may indicate a downlink slot or an uplink slot in place of what was an SBFD slot in the TDD configuration 402 (not shown in FIG. 4). In yet another example, the SBFD configuration 408 may indicate a downlink slot or an uplink slot in place of what was an uplink slot or a downlink slot, respectively, in the TDD configuration 402. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 4). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the TDD configuration 402 to the SBFD configuration 408, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the SBFD configuration 408 rather than the TDD configuration 402), and increased network resource utilization (e.g., by using both the DL BWP and the UL BWP simultaneously instead of only the DL BWP or the UL BWP).

As indicated above, FIG. 4 is provided as an example. Other examples may differ from what is described with respect to FIG. 4.

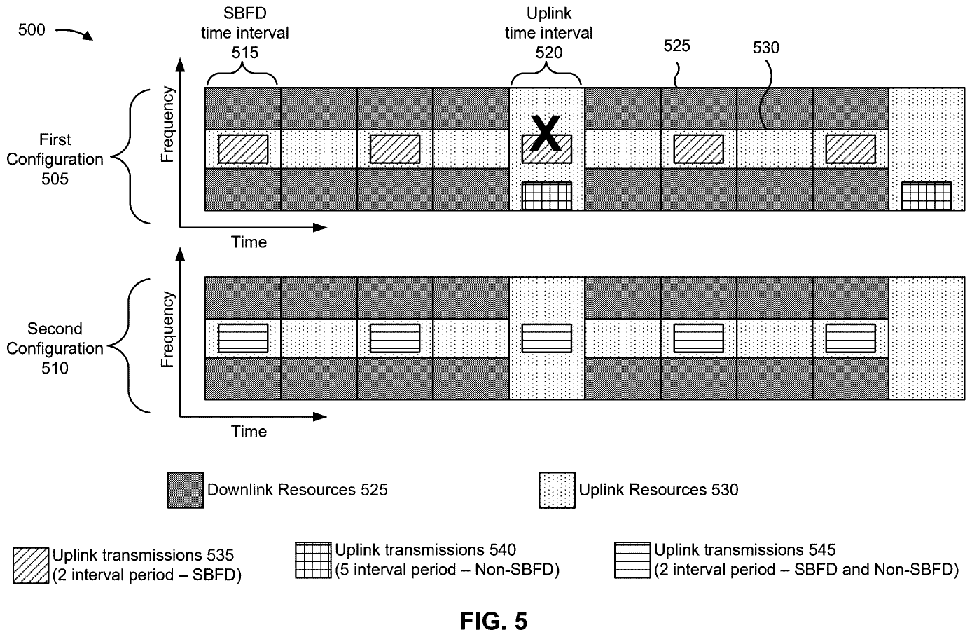

FIG. 5 is a diagram illustrating an example 500 of multiple types of configurations for SBFD operation. In some instances, example 500 may implement or be implemented by one or more aspects of FIGS. 1 through 4. For instance, FIG. 5 illustrates wireless communications between the network node 110 and the UE 120.

FIG. 5 illustrates one or more SBFD time intervals 515, which may be examples of SBFD time intervals described with reference to FIG. 4. For example, the SBFD time intervals 515 may include two downlink frequency subbands (e.g., for downlink transmissions by the network node 110) separated in the frequency domain by an uplink frequency subband (e.g., for uplink transmissions by the UE 120). For example, the downlink frequency subbands may span a set of downlink resources 525 and the uplink frequency subband may span a set of uplink resources 530. Accordingly, during the SBFD time interval 515, the network node 110 may concurrently transmit (to multiple UEs 120) one or more downlink transmissions and receive (from one or more UE 120s 120) one or more uplink transmissions. In some examples, an SBFD time interval 515 may include any number of uplink frequency subbands and any number of downlink frequency subbands in any uplink/downlink frequency subband pattern. In some examples, an SBFD time interval 515 may span one or more symbols, one or more sub-slots, one or more mini-slots, or one or more slots.

FIG. 5 illustrates one or more uplink time intervals 520, which may be examples of the uplink time intervals described with reference to FIG. 4 (e.g., uplink slot 406 and 418). For example, the uplink time intervals 520 may span a frequency bandwidth that includes uplink resources 530. In other words, the uplink time intervals 520 may be TDD time intervals configured for the UE 120 to transmit one or more uplink transmissions. In some examples, an uplink time interval 520 may span one or more symbols, one or more sub-slots, one or more mini-slots, or one or more slots. In some examples, “TDD time intervals” may be referred to elsewhere herein as “non-SBFD time intervals.”

In some examples, the UE 120 may be an SBFD-aware UE 120. In other words, the UE 120 may be aware of the one or more downlink subbands and the one or more uplink subbands of the SBFD time intervals. In accordance with the UE 120 being SBFD-aware, the UE 120 may transmit uplink transmissions or receive downlink transmissions across one or more of SBFD symbols and non-SBFD symbols across multiple time intervals. In some examples, a given uplink transmission or downlink transmission may be within a single time interval that includes exclusively SBFD symbols or exclusively non-SBFD symbols.

In some examples, the network node 110 may transmit, and the UE 120 may receive, one of a first configuration 505 or a second configuration 510 associated with SBFD operations and non-SBFD operations. For example, as described elsewhere herein, the fist configuration 505 may enable the UE 120 to transmit uplink transmissions during one of the SBFD time intervals 515 or non-SBFD time intervals and the second configuration 510 may enable the UE 120 to transmit uplink transmissions during both SBFD time intervals and non-SBFD time intervals. In some examples, the network node 110 may indicate one of the first configuration 505 or the second configuration 510 as part of an SBFD configuration (e.g., the SBFD configuration 408 described with reference to FIG. 4). For example, the network node 110 may transmit the SBFD configuration via one or more of RRC signaling, MAC signaling (e.g., via one or more MAC-CEs), or DCI signaling.

If the UE 120 operates in accordance with the first configuration 505, then wireless transmissions and receptions at the UE 120 may occur exclusively during SBFD symbols or exclusively during non-SBFD symbols. For example, as shown with reference to the first configuration 505, the UE 120 may transmit multiple uplink transmissions 535 in accordance with a period of two time intervals. Additionally, the multiple uplink transmissions 535 may be configured exclusively for SBFD symbols (e.g., in accordance with the first configuration 505). Accordingly, the UE 120 may drop one or more uplink transmissions 535 that span non-SBFD symbols (e.g., drop uplink transmissions 535 that are during uplink time intervals 520). Further, as shown with reference to the first configuration 505, the UE 120 may transmit multiple uplink transmission 540 in accordance with a period of five time intervals. Additionally, the multiple uplink transmissions 535 may be configured for exclusively non-SBFD symbols (e.g., in accordance with the first configuration 505). Accordingly, the UE 120 may drop one or more uplink transmissions 540 that span SBFD symbols (e.g., drop uplink transmissions 540 that are during SBFD time intervals 515). In some examples, operations in accordance with the first configuration 505 may reduce complexity associated with differences in interference levels between SBFD and non-SBFD time intervals. Therefore, by transmitting uplink transmissions via exclusively SBFD symbols or via exclusively non-SBFD symbols, the UE 120 may use a same set of power control parameters across multiple uplink transmissions.

If the UE 120 operates in accordance with the second configuration 510, then wireless transmissions and receptions at the UE 120 may occur during both SBFD symbols and non-SBFD symbols. For example, as shown with reference to the second configuration 510, the UE 120 may transmit multiple uplink transmissions 545 in accordance with a period of two time intervals. Additionally, the multiple uplink transmissions 545 may be configured for transmission during both SBFD symbols and non-SBFD symbols (e.g., in accordance with the second configuration 510). In some examples, operations in accordance with the second configuration 510 may increase data throughput and reduce latency based on reducing a number of uplink transmissions that a UE 120 may drop.

In some examples, the network node 110 may indicate, to the UE 120, the second configuration 510 on a per bandwidth part (BWP) basis. For example, if the network node 110 indicates the second configuration 510 for a downlink BWP, then the UE 120 may operate in accordance with the second configuration 510 for one or more downlink messages (e.g., at least PDSCHs) within the downlink BWP. If the network node 110 indicates the second configuration 510 for an uplink BWP, then the UE 120 may operate in accordance with the second configuration 510 for one or more uplink messages (e.g., at least PUCCHs and PUSCHs) within the uplink BWP. In some examples, the UE 120 may operate in accordance with the first configuration 505 for SRS transmissions (e.g., even if the second configuration 510 is configured). In some examples, the first configuration 505 may be a default configuration for the UE 120. That is, the second configuration 510 may be based on the UE 120 supporting the second configuration 510 (e.g., based on a UE 120 capability).

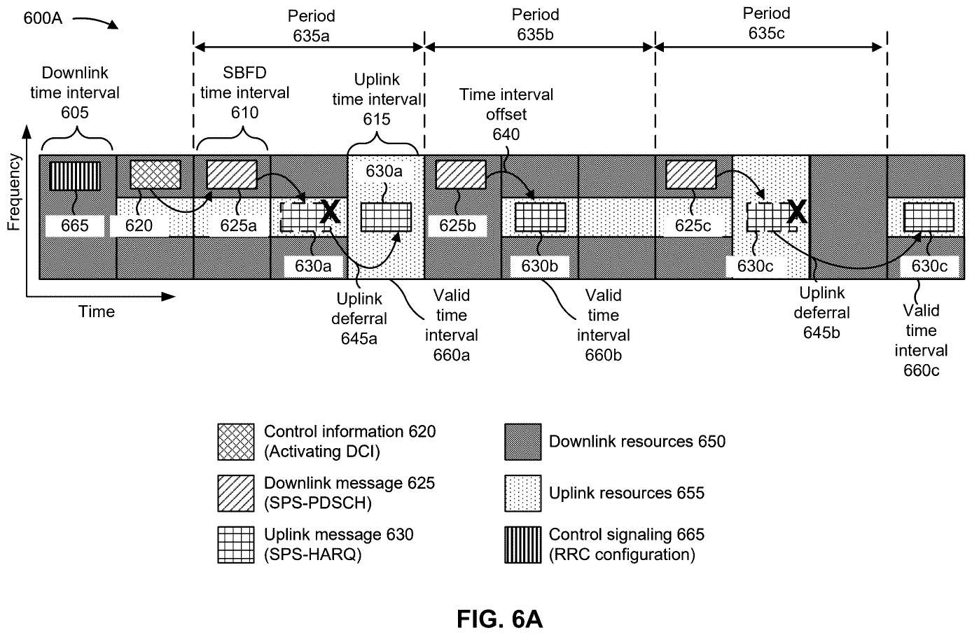

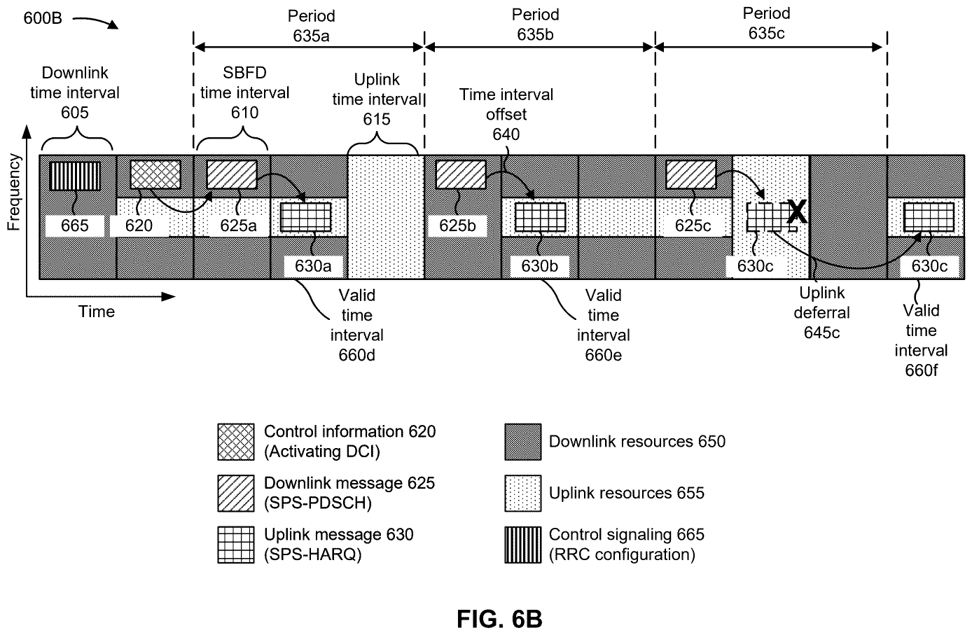

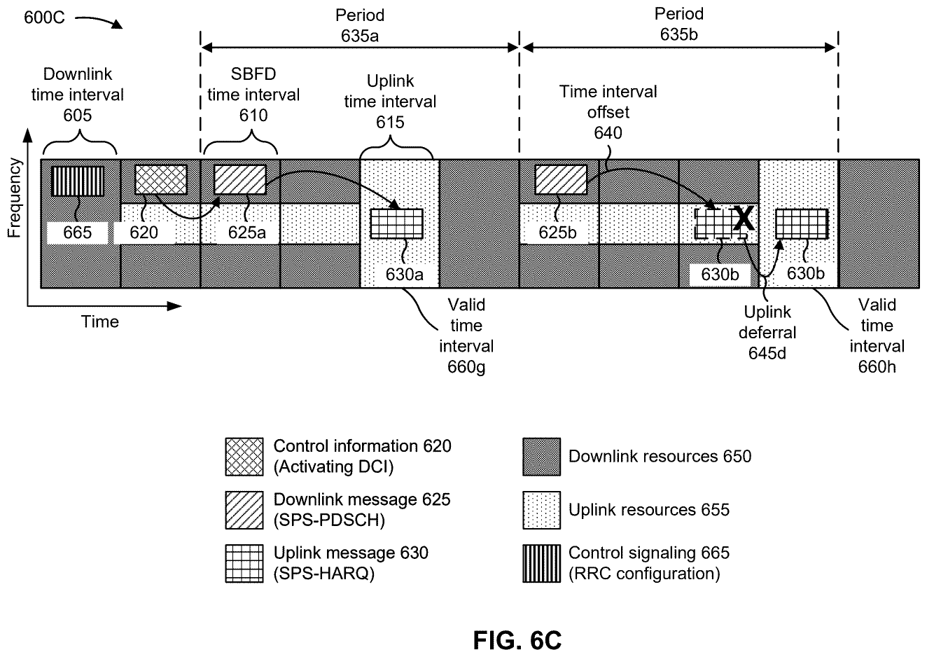

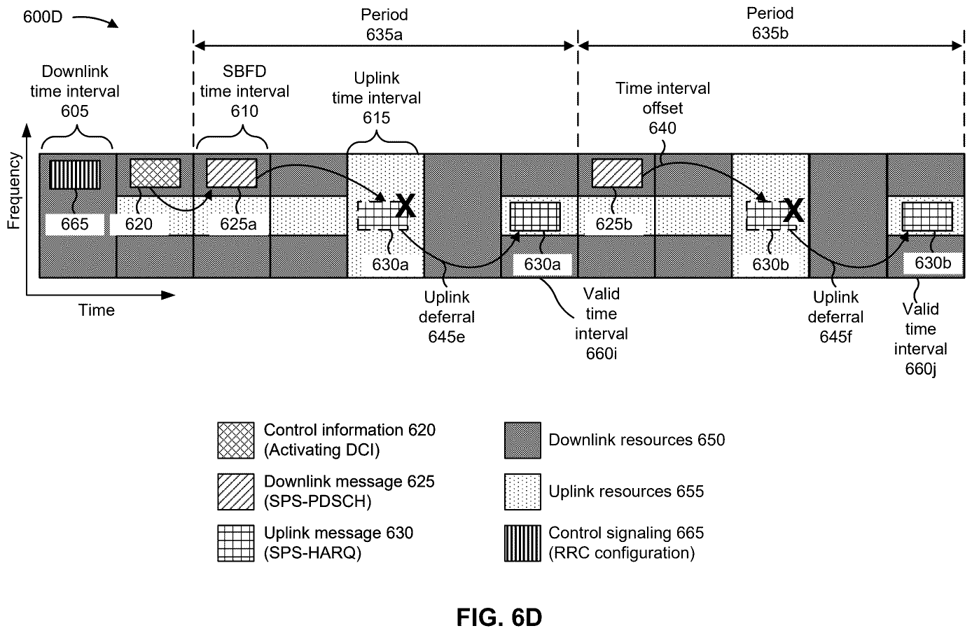

FIGS. 6A through 6D are diagrams illustrating examples 600A, 600B, 600C, and 600D associated with uplink message deferral in accordance with an SBFD configuration. In some instances, examples 600A through 600D may implement or be implemented by one or more aspects of FIGS. 1 through 5. For instance, FIGS. 6A through 6D may illustrate wireless communications between the network node 110 and the UE 120. Additionally, SBFD time intervals 610 and uplink time intervals 615 may be respective examples of SBFD time intervals 515 and uplink time intervals 520, as described with reference to FIG. 5. Additionally, downlink resources 650 and uplink resources 655 may be respective examples of downlink resources 525 and uplink resource 530, as described with reference to FIG. 5.

FIGS. 6A through 6D illustrate one or more downlink time intervals 605, which may be examples of the downlink time intervals described with reference to FIG. 4 (e.g., downlink slots 404a, 404b, 404c, and 410). For example, the downlink time intervals 605 may span a frequency bandwidth that includes downlink resources 650. In other words, the downlink time intervals 605 may be TDD time intervals configured for the network node 110 to transmit one or more downlink transmissions. In some examples, a downlink time interval 605 may span one or more symbols, one or more sub-slots, one or more mini-slots, or one or more slots. In some examples, the downlink time intervals 605 and the uplink time intervals 615 may be referred to elsewhere herein as “non-SBFD time intervals.”

In some examples, the downlink time intervals 605, the SBFD time intervals 610, and the uplink time intervals 615 may be part of an SBFD configuration (e.g., the SBFD configuration 408) that includes one or more SBFD time intervals and one or more non-SBFD time intervals. In some examples, the SBFD configuration may be associated with a time interval format pattern that repeats over time. For instance, in examples 600A through 600D, the time interval format pattern may start with a downlink time interval 605, followed by three consecutive SBFD time intervals 610, and end with an uplink time interval 615 (e.g., and repeat over time). In some other examples, the time interval format pattern may include any number of downlink time intervals 605, any number SBFD time intervals 610, and any number of uplink time intervals 615, in any order.

As shown in FIGS. 6A through 6D, the network node 110 may transmit control information 620 (e.g., an activating DCI or an activating MAC-CE) that triggers a transmission of multiple downlink messages 625 (e.g., downlink messages 625a, 625b, and 625c) and multiple uplink transmissions 630 (e.g., uplink messages 630a, 630b, and 630c). With reference to examples 600A through 600D, downlink messages 625 may be SPS-PDSCHs, but in other examples may be any other type of downlink transmission described elsewhere herein. With reference to examples 600A through 600D, the uplink messages 630 may be SPS-HARQs associated with the SPS-PDSCHs, but in other examples may be any other type of uplink transmission described elsewhere herein. In some examples, the control information 620 may indicate a time interval offset 640 that may indicate a number of time intervals to wait, after transmission downlink message 625, before transmitting an associated uplink message 630. In some examples, the time interval offset 640 may be an example of the time slot offset 330, with reference to FIG. 3 (e.g., a K1 value).

As shown in FIGS. 6A through 6D, the set of downlink messages 625 and the set of uplink message 630 may be respectively associated with a set of periods 635 (e.g., periods 635a, 635b, and 635c). The set of periods 635 may be time periods in the time domain. In some examples, the control information 620 may indicate the duration of the set of periods 635. In some examples, control signaling 665 may indicate the duration of the set of periods 635.

Examples 600A through 600D may be associated with the UE 120 performing an uplink deferral 645 for one or more of the uplink messages 630. In some examples, the uplink deferral 645 may be an example of the HARQ deferral 335, with reference to FIG. 3. For example, if the UE 120 is provided with an sps-HARQ-Deferral parameter (described elsewhere herein), then the UE 120 may determine a valid symbol type to transmit the uplink messages 630.

With reference to example 600A (e.g., where the time interval offset 640 is set to one (K1=1)), the UE 120 may determine the valid symbol type in accordance with the network node 110 transmitting, and the UE 120 receiving, the control signaling 665. In some examples, the control signaling 665 may be semi-static based on an RRC configuration (e.g., RRC signaling). In some other examples, the control signaling 665 may be one or more of MAC signaling or DCI signaling. The control signaling 665 may indicate a valid symbol type per uplink message 630 (e.g., RRC configuration={‘SBFD’, ‘non-SBFD’} per PUCCH resource). In some examples, the valid symbol types indicated for the uplink message 630 via the control signaling 665 may be independent of the valid symbol types associated with the downlink messages 625. In example 600A, the control signaling 665 may indicate a valid symbol type of “non-SBFD” for the uplink message 630a, a valid symbol type of “SBFD” for the uplink message 630b, and a valid symbol type of “SBFD” for the uplink message 630c. Accordingly, the UE 120 may apply an uplink deferral 645a to defer the uplink message 630a to a next available non-SBFD time interval (e.g., a valid time interval 660a), maintain uplink message 630b in the current SBFD time interval (e.g., a valid time interval 660b), and apply an uplink deferral 645b to defer the uplink message 630c to a next available SBFD time interval (e.g., a valid time interval 660c). The control signaling 665 may enable different valid symbol types for the set of uplink messages 630, which may increase flexibility in how the set of uplink messages 630 are scheduled.

In some other examples, the control signaling 665 may indicate a single valid symbol type for the multiple uplink messages 630. For instance, the control signaling 665 may indicate a valid symbol type of “SBFD” to apply to each of uplink message 630a, 630b, and 630c. In such an instance, with reference to example 600A, the UE 120 would alternatively maintain the uplink message 630a in the current associated SBFD time interval 610, maintain the uplink message 630b in the current associated SBFD time interval 610, and apply the uplink deferral 645b to defer the uplink message 630c to a next available SBFD time interval (e.g., a valid time interval 660c).

Alternatively, the control signaling 665 may indicate a valid symbol type of “non-SBFD” to apply to each of uplink message 630a, 630b, and 630c. In such an instance, with reference to example 600a, the UE 120 may apply the uplink deferral 645a to defer the uplink message 630a to a next available SBFD time interval (e.g., the valid time interval 660b) and, alternatively, maintain the uplink message 630c in the current associated non-SBFD time interval. Additionally, the UE may apply an uplink deferral 645 to defer the uplink message 630b to a next available non-SBFD time interval, which is the non-SBFD time interval associated with the uplink message 630c. Accordingly, the UE may multiplex the uplink message 630b and 630c in a single uplink message for transmission (e.g., in accordance with techniques provided with reference to FIG. 3). By using a same valid symbol type that applies to multiple uplink messages 630, the control signaling 665 may enable indication of a valid symbol type while reducing signaling overhead.

With reference to examples 600B and 600C, the UE 120 may determine the valid symbol type in accordance with a time interval type of an initial uplink message 630 after the control information 620. For example, with reference to example 600B as shown in FIG. 6B (e.g., where the time interval offset is set to one (K1=1)), the uplink message 625a is in an SBFD time interval, and therefore the valid symbol type is “SBFD” for the uplink messages 630. Accordingly, the UE 120 may maintain uplink message 630a in the current SBFD time interval (e.g., a valid time interval 660d), maintain uplink message 630b in the current SBFD time interval (e.g., a valid time interval 660e), and apply an uplink deferral 645c to defer the uplink message 630c to a next available SBFD time interval (e.g., a valid time interval 660f).

Alternatively, with reference to example 600C shown in FIG. 6C (e.g., where the time interval offset is set to two (K1=2)), the uplink message 625a is in a non-SBFD time interval, and therefore the valid symbol type is “non-SBFD” for the uplink messages 630. Accordingly, the UE 120 may maintain uplink message 630a in the current non-SBFD time interval (e.g., a valid time interval 660g) and apply an uplink deferral 645d to defer the uplink message 630b to a next available non-SBFD time interval (e.g., a valid time interval 660h).

With reference to examples 600B and 600C, the UE 120 may determine the time interval of the initial uplink message 630 based on a bitfield PDSCH-to-HARQ_feedback timing indicator field in the control information 620. If the bitfield PDSCH-to-HARQ_feedback is not included in the control information 620, then the UE 120 may determine the time interval of the initial uplink message 630 via a parameter dl-DataToUL-ACK (e.g., indicated from the network node 110 to the UE 120 via RRC signaling). By using the time interval of the initial uplink message to determine the valid symbol type (e.g., in accordance with examples 600B and 600C), the network node 110 may reduce signaling overhead associated with indicating respective valid symbol types for different uplink messages 630. Additionally, the multiple uplink messages 630 may use the same valid symbol type, which may reduce complexity associated with the UE 120 transmitting multiple uplink messages 630.

With reference to example 600D (e.g., where the time interval offset is set to two (K1=2)), the UE 120 may determine the valid symbol type in accordance with a time interval type of the initial downlink message 625 after the control information 620. For example, the downlink message 625a is in an SBFD time interval, and therefore the valid symbol type is “SBFD” for the uplink messages 630. Accordingly, the UE 120 may apply an uplink deferral 645e to defer the uplink message 630a to a next available SBFD time interval (e.g., a valid time interval 660i) and apply an uplink deferral 645f to defer the uplink message 630b to a next available SBFD time interval (e.g., a valid time interval 660j). By using the time interval of the initial downlink message to determine the valid symbol type (e.g., in accordance with example 600D), the network node 110 may reduce signaling overhead associated with indicating respective valid symbol types for different uplink messages 630. Additionally, the multiple uplink messages 630 may use the same valid symbol type, which may reduce complexity associated with the UE 120 transmitting the multiple uplink messages 630.

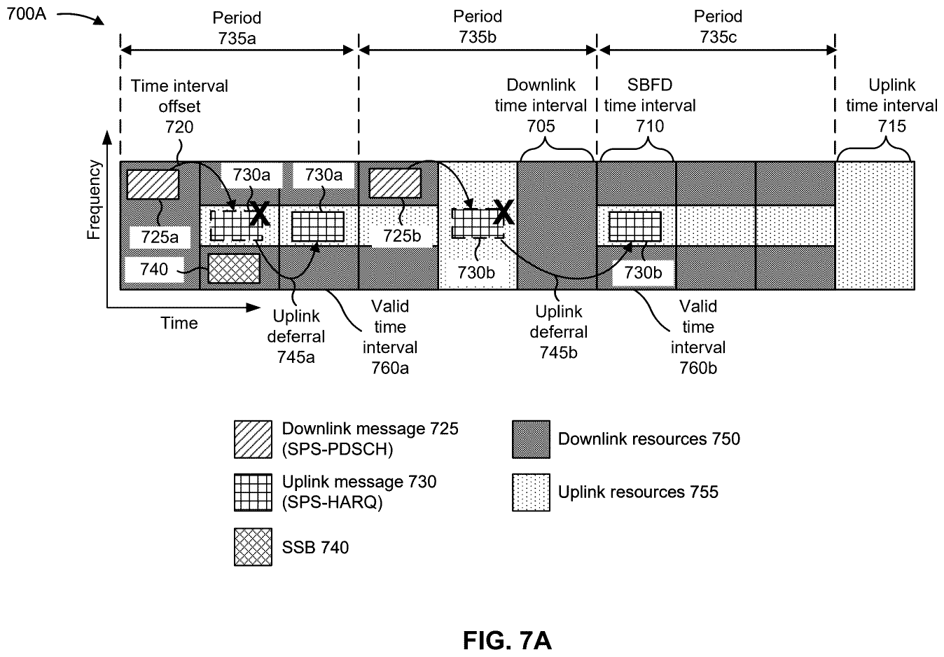

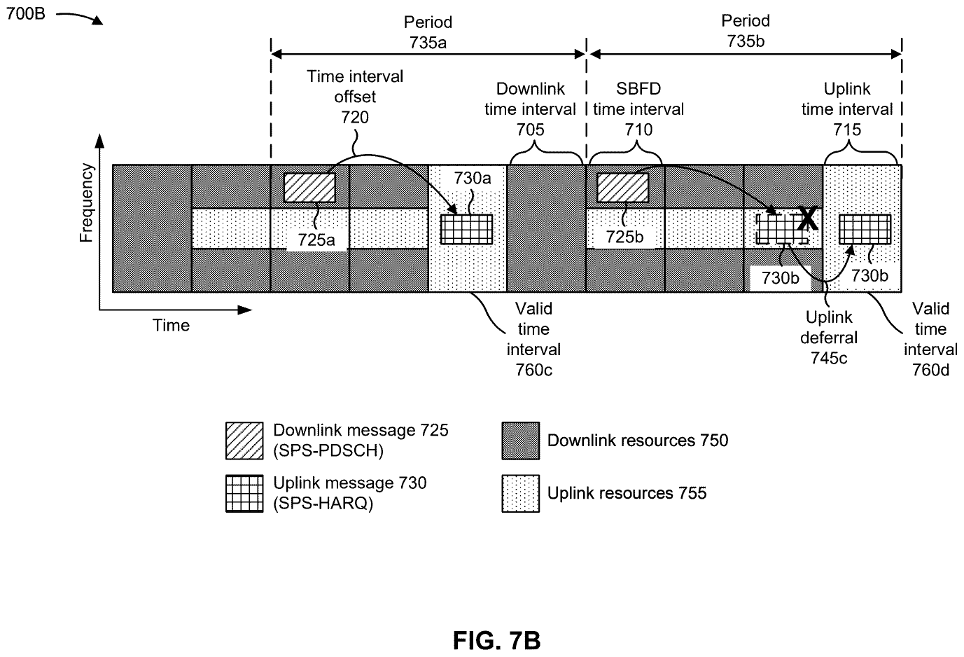

FIGS. 7A and 7B are diagrams illustrating examples 700A and 700B associated with uplink message deferral in accordance with a first configuration for SBFD operations. In some instances, examples 700A and 700B may implement or be implemented by one or more aspects of FIGS. 1 through 6. For instance, FIGS. 7A and 7B illustrate wireless communications between the network node 110 and the UE 120. In some examples, downlink time intervals 705, SBFD time intervals 710, and uplink time intervals 715 may be respective examples of the downlink time intervals 605, the SBFD time intervals 610, and the uplink time intervals 615. In other words, examples 700A and 700B may be associated with a same SBFD configuration as examples 600A through 600D. In some examples, a time interval offset 720 may be an example of the time interval offset 640. In some examples, downlink messages 725 (e.g., downlink message 725a and 725b) and uplink messages 730 (e.g., uplink message 730a and 730b) may be respective examples of the downlink messages 625 and the uplink messages 630. In some examples, periods 735 (e.g., periods 735a, 735b, and 735c) may be examples of periods 635. In some examples, uplink deferrals 745 and valid time intervals 760 may be respective examples of the uplink deferrals 645 and the valid time intervals 660. In some examples, downlink resources 750 and uplink resources 755 may be respective examples of the downlink resources 650 and the uplink resources 655.

Examples 700A and 700B may be associated with uplink deferral (e.g., in accordance with sps-HARQ-Deferral) of the uplink messages 730, if the network node 110 configures the UE 120 with the first configuration 505. In other words, the UE 120 may be enabled or configured to transmit the uplink messages either during the SBFD time intervals 710 or during the non-SBFD time intervals (e.g., the uplink time intervals 715 or flexible time intervals).

With reference to example 700A, the network node 110 may configure the UE 120 with (or the UE 120 may determine) a valid symbol type for the uplink messages 730 that is an SBFD-type (e.g., SBFD time intervals 710 are valid for SPS-HARQ transmissions). In some examples, the valid symbol type may be configured or determined to be the SBFD-type in accordance with one or more aspects provided with reference to FIGS. 6A through 6D.

In accordance with example 700A, the UE 120 may defer an uplink message 730 if the uplink message 730 is associated with one or more SBFD symbols where at least one symbol overlaps with an SSB 740 or a Type-0-CSS CORESET. For instance, the UE 120 may apply an uplink deferral 745a to the uplink message 730a based on one or more first symbols of the uplink message 730a overlapping in time with one or more second symbols of the SSB 740. Accordingly, the uplink deferral 745a may move the uplink message 730a to a next available SBFD time interval 710 such that the uplink message 730a spans one or more SBFD symbols that do not overlap with an SSB or a Type-0-CSS CORESET (e.g., a valid time interval 760a).

In accordance with example 700A, the UE 120 may defer an uplink message 730 if the uplink message 730 is associated with one or more non-SBFD symbols (e.g., during a non-SBFD time interval). For instance, the UE 120 may apply an uplink deferral 745b to the uplink message 730b based on one or more symbols of the uplink message 730b overlapping in time with one or more uplink symbols (e.g., non-SBFD symbols). Accordingly, the uplink deferral 745b may move the uplink message 730b to a next available SBFD time interval 710 such that the uplink message 730b spans one or more SBFD symbols that do not overlap with an SSB or a Type-0-CSS CORESET (e.g., a valid time interval 760b).

By operating in accordance with aspects of example 700a, the UE 120 may transmit the uplink messages 730 during SBFD time intervals 710 while reducing potential collisions with receiving downlink messages (e.g., an SSB or a Type-0-CSS CORESET).

With reference to example 700B, the network node 110 may configure the UE 120 with (or the UE 120 may determine) a valid symbol type for the uplink messages 730 that is a non-SBFD-type (e.g., non-SBFD time intervals are valid for SPS-HARQ transmissions). In some examples, the valid symbol type may be configured or determined to be the non-SBFD-type in accordance with one or more aspects provided with reference to FIGS. 6A through 6D.

In accordance with example 700B the UE 120 may defer an uplink message 730 if the uplink message 730 is associated with one or more non-SBFD symbols where at least one symbol overlaps with an SSB or a Type-0-CSS CORESET (e.g., during a flexible time interval that is configured as a downlink time interval 705). Additionally, the UE 120 may defer an uplink message 730 if the uplink message 730 is associated with one or more downlink symbols (e.g., during a downlink time interval 705). Additionally, the UE 120 may defer an uplink message 730 if the uplink message 730 is associated with one or more SBFD symbols (e.g., during an SBFD time interval 710). Alternatively, the UE 120 may determine that a time interval is valid if the one or more symbols of the uplink message 730 are one or more uplink symbols, or one or more flexible symbols that do not overlap with SSB symbols or symbols that belong to a Type-0-CSS CORESET.

In accordance with example 700B, the UE 120 may maintain the uplink message 730a in a current time interval (e.g., a valid time interval 760c), based on the current time interval being an uplink time interval 715.

In accordance with example 700B, the UE 120 may apply an uplink deferral 745c to the uplink message 730b based on one or more symbols of the uplink message 730b overlapping in time with one or more SBFD symbols. Accordingly, the uplink deferral 745c may move the uplink message 730b to a next available non-SBFD time interval such that the uplink message 730b spans one or more uplink or flexible symbols that do not overlap with an SSB or a Type-0-CSS CORESET (e.g., a valid time interval 760d).

By operating in accordance with aspects of example 700a, the UE 120 may transmit the uplink messages 730 during non-SBFD time intervals while reducing potential collisions with receiving downlink messages (e.g., an SSB or a Type-0-CSS CORESET).

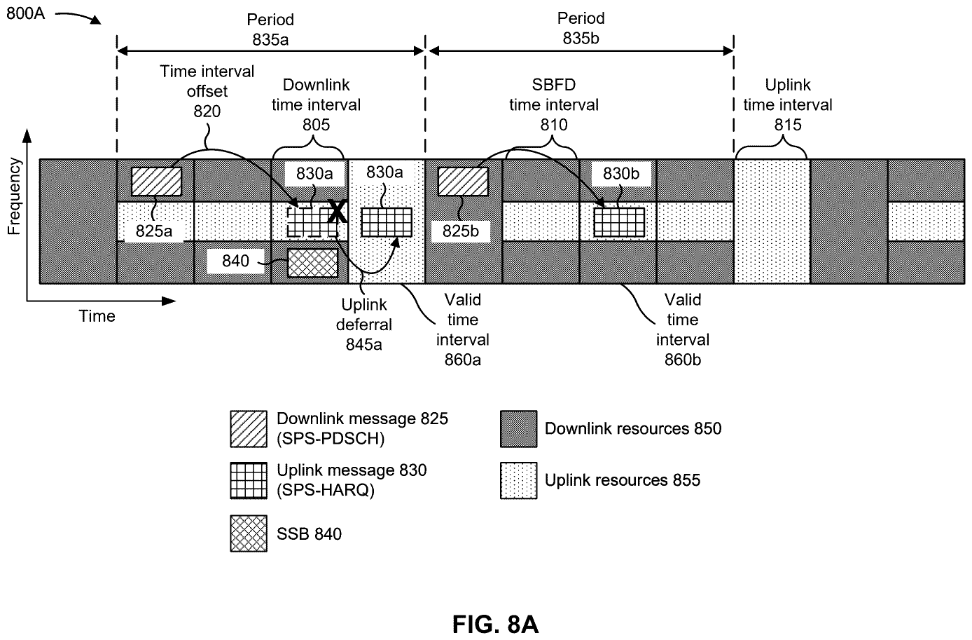

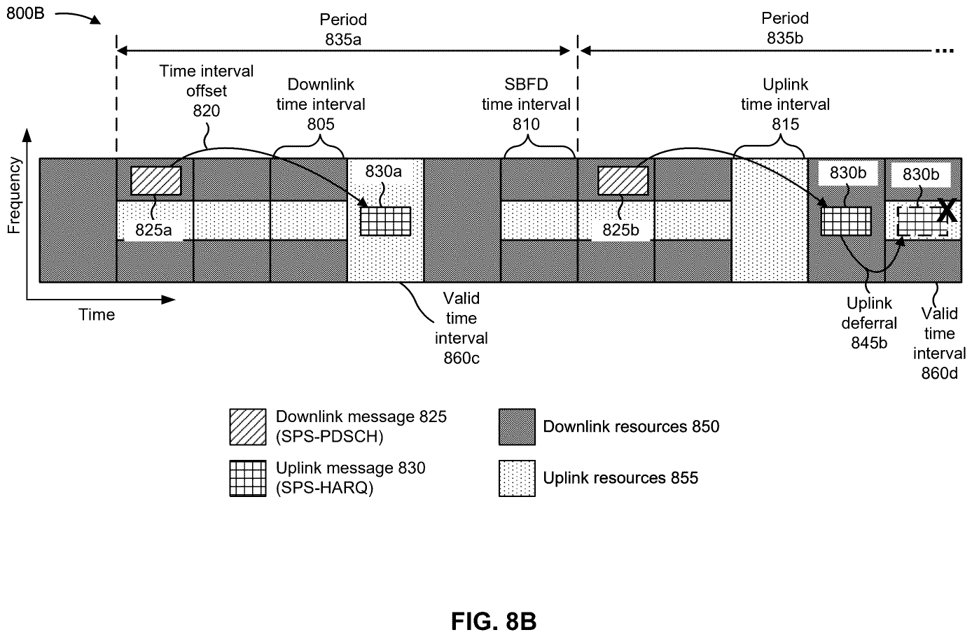

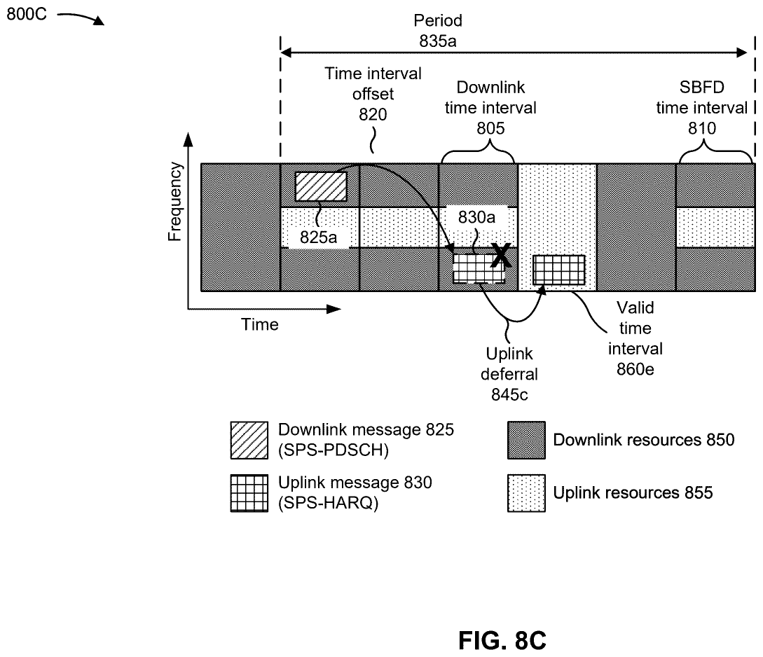

FIGS. 8A through 8C are diagrams illustrating examples 800A through 800C associated with uplink message deferral in accordance with a second configuration for SBFD operations. In some instances, examples 800A through 800C may implement or be implemented by one or more aspects of FIGS. 1 through 6. For instance, FIGS. 8A through 8C may illustrate wireless communications between the network node 110 and the UE 120. In some examples, downlink time intervals 805, SBFD time intervals 810, and uplink time intervals 815 may be respective examples of the downlink time intervals 605, the SBFD time intervals 610, and the uplink time intervals 615. In other words, examples 800A through 800C may be associated with a same SBFD configuration as examples 600A through 600D. In some examples, a time interval offset 820 may be an example of the time interval offset 640. In some examples, downlink messages 825 (e.g., downlink messages 825a and 825b) and uplink messages 830 (e.g., uplink messages 830a and 830b) may be respective examples of the downlink messages 625 and the uplink messages 630. In some examples, periods 835 (e.g., periods 835a and 835b) may be examples of periods 635. In some examples, uplink deferrals 845 and valid time intervals 860 may be respective examples of the uplink deferrals 645 and the valid time intervals 660. In some examples, downlink resources 850 and uplink resources 855 may be respective examples of the downlink resources 650 and the uplink resources 655.

Examples 800A through 800C may be associated with uplink deferral (e.g., in accordance with sps-HARQ-Deferral) of the uplink messages 830, if the network node 110 configures the UE 120 with the second configuration 510. In other words, the UE 120 may be enabled or configured to transmit the uplink messages 830 during both the SBFD time intervals 810 or during the non-SBFD time intervals (e.g., the uplink time intervals 815 or flexible time intervals).

With reference to example 800A (where K1=2) and example 800B (where K1=3), the UE 120 may defer an uplink message 830 if the uplink message 830 is associated with one or more non-SBFD downlink symbols (e.g., during a downlink time interval 805). Additionally, the UE 120 may defer an uplink message 830 if the uplink message 830 is associated with one or more non-SBFD flexible symbols, where one or more first symbols of the uplink message 830 overlap in time with one or more second symbols associated with an SSB 840 or a Type-0-CSS CORESET. Additionally, the UE 120 may defer an uplink message 830 if the uplink message 830 is associated with one or more SBFD symbols, where one or more first symbols of the uplink message 830 overlap in time with one or more second symbols associated with an SSB 840 or a Type-0-CSS CORESET.

If the UE 120 determines to defer an uplink message 830, then the UE 120 may apply an uplink deferral 845 to move the uplink message 830 to a next available time interval such that the one or more symbols of the uplink message 830 are one or more uplink symbols, one or more flexible symbols that do not overlap with SSB symbols or symbols that belong to a Type-0-CSS CORESET, or one or more SBFD symbols that do not overlap with SSB symbols or symbols that belong to a Type-0-CSS CORESET.

With reference to example 800A, the UE 120 may apply an uplink deferral 845a to the uplink message 830a based on one or more first symbols of the uplink message 830a overlapping in time with one or more second symbols of the SSB 840. Accordingly, the uplink deferral 845a may move the uplink message 830a to a next available time interval such that the uplink message 830a spans one or more uplink, flexible, or SBFD symbols that do not overlap with an SSB or a Type-0-CSS CORESET (e.g., a valid time interval 860a). Additionally, the UE 120 may maintain the uplink message 830b in a current time interval (e.g., a valid time interval 860b) based on the current time interval being an SBFD time interval 810 with no SSB symbols or symbols associated with a Type-0-CSS CORESET that overlap with the uplink message 830b.

With reference to example 800B, the UE 120 may maintain the uplink message 830a in a current time interval (e.g., a valid time interval 860c) based on the current time interval being an uplink time interval 815. Additionally, the UE 120 may apply an uplink deferral 845b to the uplink message 830b based on one or more first symbols of the uplink message 830b overlapping in time with one or more downlink symbols (e.g., during a downlink time interval). Accordingly, the uplink deferral 845b may move the uplink message 830b to a next available time interval such that the uplink message 830b spans one or more uplink, flexible, or SBFD symbols that do not overlap with an SSB or a Type-0-CSS CORESET (e.g., a valid time interval 860d).

With reference to examples 800A through 800C, the SBFD configuration (e.g., the SBFD configuration 408) may include a configuration of PUCCH resources in a system supporting SBFD that may include separate frequency settings for SBFD symbols and non-SBFD symbols (e.g., within the same PUCCH-Resource configuration). Accordingly, the SBFD configuration may indicate configurations for a startingPRB parameter and a secondHopPRB parameter for SBFD and non-SBFD symbols. In some examples, the SBFD configuration may include RRC parameters that have been added within the PUCCH-Resource framework to facilitate configuration of the startingPRB parameter and the secondHopPRB parameter for SBFD-aware UEs. Additionally, the SBFD configuration may include Pucch-ResourceId, which indicates that a set of PUCCH resources for transmission of the uplink messages 830 may be a unified identification (e.g., jointly defined for both SBFD and non-SBFD symbols). Additionally, multiple PUCCH resources that share a same Pucch-ResourceId may be collectively considered as a single resource.

With reference to examples 800A and 800B, the network node 110 may configure the UE 120 with PUCCH resources that may be configured with separate frequency resources for SBFD time intervals and non-SBFD time intervals. For example, for SBFD time intervals, the PUCCH resources may be configured with the uplink resources 855 that are within an uplink frequency subband of the SBFD time intervals (e.g., uplink messages 830 in SBFD time intervals are scheduled in the uplink frequency subband). Additionally, for non-SBFD time intervals, the PUCCH resources may be configured with the uplink resources 855 across the full frequency band of the non-SBFD time intervals (e.g., uplink messages 830 in non-SBFD time intervals can be scheduled across the full frequency band).

With reference to example 800C, for sps-HARQ-Deferral, the UE 120 may be configured with the second configuration 510 and configured with PUCCH resources with one set of frequency resources across both SBFD time intervals and non-SBFD time intervals (e.g., the uplink messages 830 are scheduled with the same frequency resources across both SBFD and non-SBFD time intervals).

In some examples of the second configuration 510 with one set of frequency resources configured for the PUCCH resources, the SBFD time intervals 810 are considered invalid for the uplink messages 830 (e.g., invalid for SPS-HARQ transmissions). For example, the UE 120 may apply an uplink deferral 845c to the uplink message 830a based on one or more symbols of the uplink message 830a being SBFD symbols (e.g., during an SBFD time interval 810). Accordingly, the uplink deferral 845c may move the uplink message 830a to a next available non-SBFD time interval (e.g., a valid time interval 860e).

In some examples of the second configuration 510 with one set of frequency resources configured for the PUCCH resources, an SBFD time interval 810 is considered invalid if the set of PUCCH frequency resources are outside of the uplink frequency subband (or usable uplink physical resource blocks (PRBs)) or at least one symbol of the uplink message 830 overlaps with an SSB 840 or a Type-0-CSS CORESET. For example, the UE 120 may apply the uplink deferral 845c to the uplink message 830a based on the set of PUCCH frequency resources for the uplink message 830a being outside the uplink frequency subband associated with the SBFD time intervals 810. Accordingly, the uplink deferral 845c may move the uplink message 830a to a next available non-SBFD time interval (e.g., a valid time interval 860e).

In some examples for sps-HARQ-Deferral, the UE 120 may use the first configuration 505 instead of the second configuration 510 for the techniques described herein. For example, if the network node 110 configures the UE 120 with the second configuration 510, the UE 120 may operate in accordance with the first configuration 505 for at least PUCCH transmissions (e.g., SPS-HARQ transmissions). In some examples, the UE may apply either of the first configuration 505 or the second configuration 510 for the techniques described herein. For example, if the network node 110 configures the UE 120 with the first configuration 505, then the UE 120 may operate in accordance with the first configuration 505 for at least PUCCH transmissions (e.g., SPS-HARQ transmissions) and if the network node 110 configures the UE 120 with the second configuration 510, then the UE 120 may operate in accordance with the second configuration 510 for at least PUCCH transmissions (e.g., SPS-HARQ transmissions).

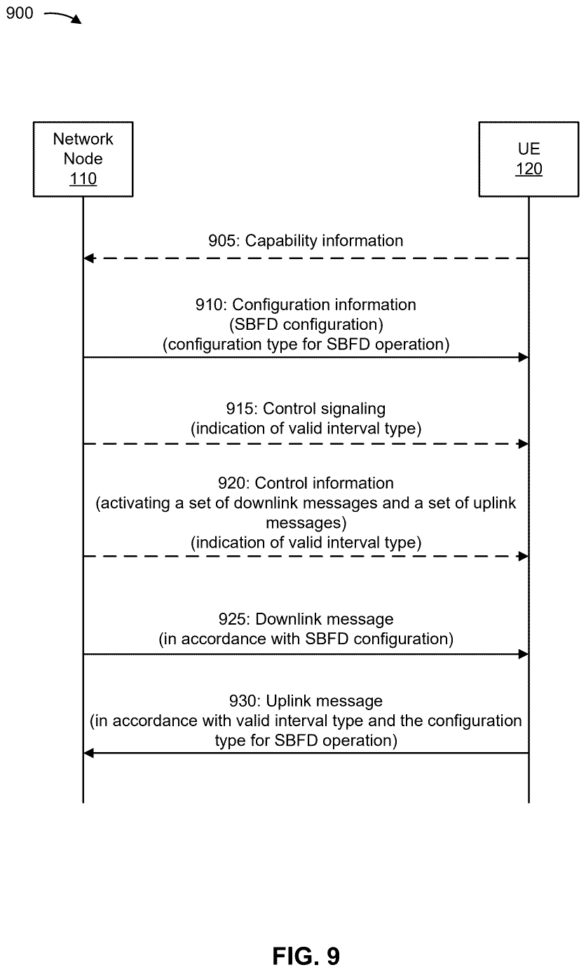

FIG. 9 is a diagram illustrating an example 900 associated with signaling that enables feedback deferral in full-duplex configuration. Example 900 may implement or be implemented by one or more aspects of FIGS. 1 through 8C. For instance, example 900 includes wireless communications between the network node 110 and the UE 120. Alternative examples of the following operations of example 900 may be implemented, where some operations are performed in a different order than described, or not described at all. In some cases, one or more operations may include additional features not mentioned below, or further operations may be added. In addition, while example 900 shows operations between the UE 120 and the network node 110, the communications may occur between any number of network devices of various types described herein.

In a first operation 905, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability or parameter that the UE 120 is an SBFD-aware UE. In other words, the capability information may indicate that the UE 120 is capable of operating in accordance with an SBFD configuration that configures one or more SBFD time intervals and one or more non-SBFD time intervals. In some examples, the capability information may indicate whether the UE 120 supports the second configuration 510. For instance, the first configuration 505 may be a default configuration type for SBFD operations, and as part of the capability information, the UE 120 may indicate whether the UE 120 additionally supports the second configuration 510. One or more operations described herein may be based on the capability information. For example, the UE 120 may perform one or more operations of example 900 in accordance with the capability information or may receive one or more of configuration information or control information that is in accordance with the capability information.

The network node 110 may determine configuration information for the UE 120 based on the capability information. For example, the network node 110 may determine that the UE 120 is capable of operating in accordance with an SBFD configuration based on the capability information indicating that the UE 120 is SBFD-aware.

In a second operation 910, the network node 110 may transmit, and the UE 120 may receive, the configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may include an SBFD configuration (e.g., the SBFD configuration 408). For example, the SBFD configuration may configure one or more SBFD time intervals (e.g., SBFD time intervals 610) and one or more non-SBFD time intervals (e.g., one or more of downlink time intervals 605, uplink intervals 615, or flexible time intervals described elsewhere herein).

In some examples, the configuration information may indicate one of a first configuration type or a second configuration type associated with SBFD operation. For example, the first configuration type may enable uplink transmissions during one of the one or more SBFD time intervals or the one or more non-SBFD time intervals (e.g., the first configuration 505). Additionally, the second configuration type may enable uplink transmissions during both of the one or more SBFD time intervals and the one or more non-SBFD time intervals (e.g., the second configuration 510).

In some examples, the configuration information may indicate one or more frequency resource sets associated with the uplink transmission (e.g., one or more PUCCH resource sets). For example, the configuration may indicate a single frequency resource set for uplink transmissions during both the SBFD time intervals and the non-SBFD time intervals. Alternatively, the configuration information may indicate a first frequency resource set for uplink transmissions during the SBFD time intervals and a second frequency resource set for uplink transmissions during the non-SBFD time intervals.

In a third operation 915, the network node 110 may optionally transmit, and the UE 120 may receive, control signaling. In some examples, the control signaling of the third operation 915 may be an example of the control signaling 665. For example, the control signaling may indicate a valid interval type (e.g., SBFD-type or non-SBFD-type) for one or more uplink messages (e.g., in accordance with techniques provided with reference to example 600A). In some examples, the control signaling may be a part of the configuration information in the second operation 910. In some examples, the control signaling may be in separate signaling from the configuration information (e.g., separate RRC signaling).

In a fourth operation 920, the network node 110 may optionally transmit, and the UE 120 may receive, control information. In some examples, the control information of the fourth operation 920 may be an example of the control information 620. For example, the control information may activate a set of downlink messages (e.g., downlink messages 625) and a set of uplink messages (e.g., uplink messages 630). In some examples, the control information may indicate the valid interval type associated with the set of uplink messages.

In some examples, the control information may activate a set of uplink messages that may include an uplink message (e.g., associated with a sixth operation 930) and an initial uplink message that is transmitted before the uplink message, where the valid time interval type may be equal to (e.g., the same as) a time interval type of a time interval associated with the initial uplink message (e.g., in accordance with techniques provided with reference to example 600B and example 600C). In some such examples, the network node 110 may transmit, and the UE 120 may receive, an indication (e.g., as part of the configuration information of the second operation 910) of a time interval offset (e.g., the time interval offset 640) for transmission of the initial uplink message relative to transmission of an initial downlink message associated with the initial uplink message, where the time interval associated with the initial uplink message may be based on the time interval offset.

In some examples, the control information may activate a set of downlink messages that includes an initial downlink message and a set of uplink messages that includes the uplink message, where the valid time interval type may be equivalent to (e.g., the same as) a time interval type of a time interval associated with the initial downlink message (e.g., in accordance with techniques provided with reference to example 600D).

In a fifth operation 925, the network node 110 may transmit, and the UE 120 may receive, a downlink message in accordance with the SBFD configuration. For example, the network node 110 may transmit the downlink message during a time interval from the one or more SBFD time intervals or the one or more non-SBFD time intervals. In some examples, transmission of the downlink message may be indicated via the control information in the fourth operation 920.

In a sixth operation 930, the UE 120 may transmit, and the network node 110 may receive, an uplink message during a valid time interval in accordance with the downlink message. For example, the valid time interval may be based on the valid time interval type (e.g., in accordance with the third operation 915 or the fourth operation 920) and the configuration type (e.g., indicated via the configuration information in the second operation 910).

In some examples, the configuration type enables the one or more uplink transmissions during one of the one or more SBFD time intervals or the one or more non-SBFD time intervals (e.g., the first configuration 505) and the valid time interval type may be an SBFD-type. Therefore, the valid time interval may be a next available SBFD time interval after a time interval associated with the downlink message, where one or more first symbols of the uplink message may be different than one or more second symbols that are associated with an SSB or associated with a CORESET used for Type-0 CSS (e.g., in accordance with techniques provided with reference to example 700A).

In some examples, the configuration type enables the one or more uplink transmissions during one of the one or more non-SBFD time intervals or the one or more SBFD time intervals (e.g., the first configuration 505) and the valid time interval type may be a non-SBFD-type. Therefore, the valid time interval may be a next available uplink or flexible time interval after a time interval associated with the downlink message, where one or more first symbols of the uplink message may be different than one or more second symbols that are associated with an SSB or associated with a CORESET used for Type-0 CSS (e.g., in accordance with techniques provided with reference to example 700B).

In some examples, the configuration type enables the one or more uplink transmissions during both the one or more non-SBFD time intervals and the one or more SBFD time intervals (e.g., the second configuration 510). Therefore, the valid time interval may be a next available uplink, flexible, or SBFD time interval after a time interval associated with the downlink message, where one or more first symbols of the uplink message are different than one or more second symbols that are associated with an SSB or associated with a CORESET used for Type-0 CSS (e.g., in accordance with techniques provided with reference to examples 800A and 800B).

In some examples, the configuration type enables the one or more uplink transmissions during both the one or more non-SBFD time intervals and the one or more SBFD time intervals (e.g., the second configuration 510) and the uplink message is associated with a single set of frequency resources (e.g., in accordance with techniques provided with reference to example 800C). In some such examples, the one or more SBFD time intervals may be one or more invalid time intervals. Alternatively, an SBFD time interval of the one or more SBFD time intervals, that includes an uplink subband outside of the single set of frequency resources, may be an invalid time interval. Additionally, or alternatively, an SBFD time interval of the one or more SBFD time intervals, that includes one or more first symbols that at least partially overlap with one or more second symbols of the uplink message and are associated with an SSB or associated with a CORESET used for Type-0 CSS, may be an invalid time interval.

In some examples, the configuration information may indicate the second configuration type. In some such examples, the UE 120 may transmit the uplink message in accordance with the first configuration type based on the uplink message being a feedback message (e.g., an SPS-HARQ).

In some examples, the configuration information may indicate that the configuration type is one of the first configuration type or the second configuration type. In some such examples, the UE 120 may transmit the uplink message in accordance with the configuration indicated via the configuration information.

FIG. 10 is a diagram illustrating an example process 1000 performed, for example, at a UE or an apparatus of a UE. Example process 1000 is an example where the apparatus or the UE (e.g., UE 120) performs operations associated with feedback deferral in full-duplex configurations.

As shown in FIG. 10, in some aspects, process 1000 may include receiving, from a network node, an SBFD configuration that configures one or more SBFD time intervals and one or more non-SBFD time intervals (block 1010). For example, the UE (e.g., using communication manager 150 or reception component 1202, depicted in FIG. 12) may receive, from a network node, an SBFD configuration that configures one or more SBFD time intervals and one or more non-SBFD time intervals, as described above.

As further shown in FIG. 10, in some aspects, process 1000 may include receiving, from the network node, a downlink message in accordance with the SBFD configuration (block 1020). For example, the UE (e.g., using communication manager 150 or reception component 1202, depicted in FIG. 12) may receive, from the network node, a downlink message in accordance with the SBFD configuration, as described above.

As further shown in FIG. 10, in some aspects, process 1000 may include transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (block 1030). For example, the UE (e.g., using communication manager 150 or transmission component 1204, depicted in FIG. 12) may transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals, as described above.

Process 1000 may include additional aspects, such as any single aspect or any combination of aspects described below or in connection with one or more other processes described elsewhere herein.

In a first aspect, process 1000 includes receiving, from the network node, control signaling that indicates the valid time interval type for the uplink message.

In a second aspect, alone or in combination with the first aspect, process 1000 includes receiving, from the network node, control information that activates a set of uplink messages that includes the uplink message and an initial uplink message that is transmitted before the uplink message, wherein the valid time interval type is equal to (e.g., the same as) a time interval type of a time interval associated with the initial uplink message.

In a third aspect, alone or in combination with one or more of the first and second aspects, process 1000 includes receiving, from the network node, an indication of a time interval offset for transmission of the initial uplink message relative to transmission of an initial downlink message associated with the initial uplink message, wherein the time interval associated with the initial uplink message is based at least in part on the time interval offset.

In a fourth aspect, alone or in combination with one or more of the first through third aspects, process 1000 includes receiving, from the network node, control information that activates a set of downlink messages that includes an initial downlink message and a set of uplink messages that includes the uplink message, wherein the valid time interval type is equivalent to (e.g., the same as) a time interval type of a time interval associated with the initial downlink message.

In a fifth aspect, alone or in combination with one or more of the first through fourth aspects, the configuration type enables the one or more uplink transmissions during one of the one or more SBFD time intervals or the one or more non-SBFD time intervals, the valid time interval type is an SBFD-type, the valid time interval is a next available SBFD time interval after a time interval associated with the downlink message, and one or more first symbols of the uplink message are different than one or more second symbols that are associated with an SSB or associated with a CORESET used for a Type-0-CSS.

In a sixth aspect, alone or in combination with one or more of the first through fifth aspects, the configuration type enables the one or more uplink transmissions during one of the one or more non-SBFD time intervals or the one or more SBFD time intervals, the valid time interval type is a non-SBFD-type, the valid time interval is a next available uplink or flexible time interval after a time interval associated with the downlink message, and one or more first symbols of the uplink message are different than one or more second symbols that are associated with an SSB or associated with a CORESET used for a Type-0-CSS.

In a seventh aspect, alone or in combination with one or more of the first through sixth aspects, the configuration type enables the one or more uplink transmissions during both the one or more non-SBFD time intervals and the one or more SBFD time intervals, the valid time interval is a next available uplink, flexible, or SBFD time interval after a time interval associated with the downlink message, and one or more first symbols of the uplink message are different than one or more second symbols that are associated with an SSB or associated with a CORESET used for a Type-0-CSS.

In an eighth aspect, alone or in combination with one or more of the first through seventh aspects, the configuration type enables the one or more uplink transmissions during both the one or more non-SBFD time intervals and the one or more SBFD time intervals and the uplink message is associated with a single set of frequency resources.

In a ninth aspect, alone or in combination with one or more of the first through eighth aspects, the one or more SBFD time intervals are one or more invalid time intervals.

In a tenth aspect, alone or in combination with one or more of the first through ninth aspects, an SBFD time interval of the one or more SBFD time intervals, that includes an uplink subband outside of the single set of frequency resources, is an invalid time interval.

In an eleventh aspect, alone or in combination with one or more of the first through tenth aspects, an SBFD time interval of the one or more SBFD time intervals, that includes one or more first symbols that at least partially overlap with one or more second symbols of the uplink message and are associated with an SSB or associated with a CORESET used for a Type-0-CSS, is an invalid time interval.

In a twelfth aspect, alone or in combination with one or more of the first through eleventh aspects, a first configuration type enables the one or more uplink transmissions during one of the one or more SBFD time intervals or the one or more non-SBFD time intervals, and a second configuration type enables the one or more uplink transmissions during both of the one or more SBFD time intervals and the one or more non-SBFD time intervals.

In a thirteenth aspect, alone or in combination with one or more of the first through twelfth aspects, process 1000 includes receiving, from the network node, configuration information that indicates the second configuration type, and transmitting, to the network node, the uplink message in accordance with the first configuration type based at least in part on the uplink message that is a feedback message.

In a fourteenth aspect, alone or in combination with one or more of the first through thirteenth aspects, process 1000 includes receiving, from the network node, configuration information that indicates the configuration type is one of the first configuration type or the second configuration type, and transmitting, to the network node, the uplink message in accordance with the configuration indicated via the configuration information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with feedback deferral in full-duplex configurations.

As shown in FIG. 11, in some aspects, process 1100 may include sending an SBFD configuration that configures one or more SBFD time intervals and one or more non-SBFD time intervals (block 1110). For example, the network node (e.g., using communication manager 150 or transmission component 1504, depicted in FIG. 15) may send an SBFD configuration that configures one or more SBFD time intervals and one or more non-SBFD time intervals, as described above.

As further shown in FIG. 11, in some aspects, process 1100 may include sending a downlink message in accordance with the SBFD configuration (block 1120). For example, the network node (e.g., using communication manager 150 or transmission component 1504, depicted in FIG. 15) may send a downlink message in accordance with the SBFD configuration, as described above.

As further shown in FIG. 11, in some aspects, process 1100 may include obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (block 1130). For example, the network node (e.g., using communication manager 150 or reception component 1502, depicted in FIG. 15) may obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals, as described above.

Process 1100 may include additional aspects, such as any single aspect or any combination of aspects described below or in connection with one or more other processes described elsewhere herein.

In a first aspect, process 1100 includes sending control signaling that indicates the valid time interval type for the uplink message.

In a second aspect, alone or in combination with the first aspect, process 1100 includes sending control information that activates a set of uplink messages that includes the uplink message and an initial uplink message that is transmitted before the uplink message, wherein the valid time interval type is equal to (e.g., the same as) a time interval type of a time interval associated with the initial uplink message.

In a third aspect, alone or in combination with one or more of the first and second aspects, process 1100 includes sending an indication of a time interval offset for transmission of the initial uplink message relative to transmission of an initial downlink message associated with the initial uplink message, wherein the time interval associated with the initial uplink message is based at least in part on the time interval offset.

In a fourth aspect, alone or in combination with one or more of the first through third aspects, process 1100 includes sending control information that activates a set of downlink messages that includes an initial downlink message and a set of uplink messages that includes the uplink message, wherein the valid time interval type is equivalent to (e.g., the same as) a time interval type of a time interval associated with the initial downlink message.

In a fifth aspect, alone or in combination with one or more of the first through fourth aspects, the configuration type enables the one or more uplink transmissions during one of the one or more SBFD time intervals or the one or more non-SBFD time intervals, the valid time interval type is an SBFD-type, the valid time interval is a next available SBFD time interval after a time interval associated with the downlink message, and one or more first symbols of the uplink message are different than one or more second symbols that are associated with an SSB or associated with a CORESET used for a Type-0-CSS.

In a sixth aspect, alone or in combination with one or more of the first through fifth aspects, the configuration type enables the one or more uplink transmissions during one of the one or more non-SBFD time intervals or the one or more SBFD time intervals, the valid time interval type is a non-SBFD-type, the valid time interval is a next available uplink or flexible time interval after a time interval associated with the downlink message, and one or more first symbols of the uplink message are different than one or more second symbols that are associated with an SSB or associated with a CORESET used for a Type-0-CSS.

In a seventh aspect, alone or in combination with one or more of the first through sixth aspects, the configuration type enables the one or more uplink transmissions during both the one or more non-SBFD time intervals and the one or more SBFD time intervals, the valid time interval is a next available uplink, flexible, or SBFD time interval after a time interval associated with the downlink message, and one or more first symbols of the uplink message are different than one or more second symbols that are associated with an SSB or associated with a CORESET used for a Type-0-CSS.

In an eighth aspect, alone or in combination with one or more of the first through seventh aspects, the configuration type enables the one or more uplink transmissions during both the one or more non-SBFD time intervals and the one or more SBFD time intervals and the uplink message is associated with a single set of frequency resources.

In a ninth aspect, alone or in combination with one or more of the first through eighth aspects, the one or more SBFD time intervals are one or more invalid time intervals.

In a tenth aspect, alone or in combination with one or more of the first through ninth aspects, an SBFD time interval of the one or more SBFD time intervals, that includes an uplink subband outside of the single set of frequency resources, is an invalid time interval.

In an eleventh aspect, alone or in combination with one or more of the first through tenth aspects, an SBFD time interval of the one or more SBFD time intervals, that includes one or more first symbols that at least partially overlap with one or more second symbols of the uplink message and are associated with an SSB or associated with a CORESET used for a Type-0-CSS, is an invalid time interval.

In a twelfth aspect, alone or in combination with one or more of the first through eleventh aspects, a first configuration type enables the one or more uplink transmissions during one of the one or more SBFD time intervals or the one or more non-SBFD time intervals, and a second configuration type enables the one or more uplink transmissions during both of the one or more SBFD time intervals and the one or more non-SBFD time intervals.

In a thirteenth aspect, alone or in combination with one or more of the first through twelfth aspects, process 1100 includes sending configuration information that indicates the second configuration type, and obtaining the uplink message in accordance with the first configuration type based at least in part on the uplink message that is a feedback message.

In a fourteenth aspect, alone or in combination with one or more of the first through thirteenth aspects, process 1100 includes sending configuration information that indicates the configuration type is one of the first configuration type or the second configuration type, and obtaining the uplink message in accordance with the configuration indicated via the configuration information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a determination component 1208, among other examples. The communication manager 150 may be included in, or implemented via, a processing system (for example, the processing system 140 described in connection with FIG. 1) of the UE.

In some aspects, the apparatus 1200 may be configured to perform one or more operations described herein in connection with FIGS. 3 through 9. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The reception component 1202 may receive, from a network node, an SBFD configuration that configures one or more SBFD time intervals and one or more non-SBFD time intervals. The reception component 1202 may receive, from the network node, a downlink message in accordance with the SBFD configuration. The transmission component 1204 may transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

The reception component 1202 may receive, from the network node, control signaling that indicates the valid time interval type for the uplink message.

The reception component 1202 may receive, from the network node, control information that activates a set of uplink messages that includes the uplink message and an initial uplink message that is transmitted before the uplink message, wherein the valid time interval type is equal to (e.g., the same as) a time interval type of a time interval associated with the initial uplink message.

The reception component 1202 may receive, from the network node, an indication of a time interval offset for transmission of the initial uplink message relative to transmission of an initial downlink message associated with the initial uplink message, wherein the time interval associated with the initial uplink message is based at least in part on the time interval offset.

The reception component 1202 may receive, from the network node, control information that activates a set of downlink messages that includes an initial downlink message and a set of uplink messages that includes the uplink message, wherein the valid time interval type is equivalent to (e.g., the same as) a time interval type of a time interval associated with the initial downlink message.

The reception component 1202 may receive, from the network node, configuration information that indicates the second configuration type.

The transmission component 1204 may transmit, to the network node, the uplink message in accordance with the first configuration type based at least in part on the uplink message that is a feedback message.

The reception component 1202 may receive, from the network node, configuration information that indicates the configuration type is one of the first configuration type or the second configuration type.

The transmission component 1204 may transmit, to the network node, the uplink message in accordance with the configuration indicated via the configuration information.

The determination component 1208 may determine the configuration type in accordance with the SBFD configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

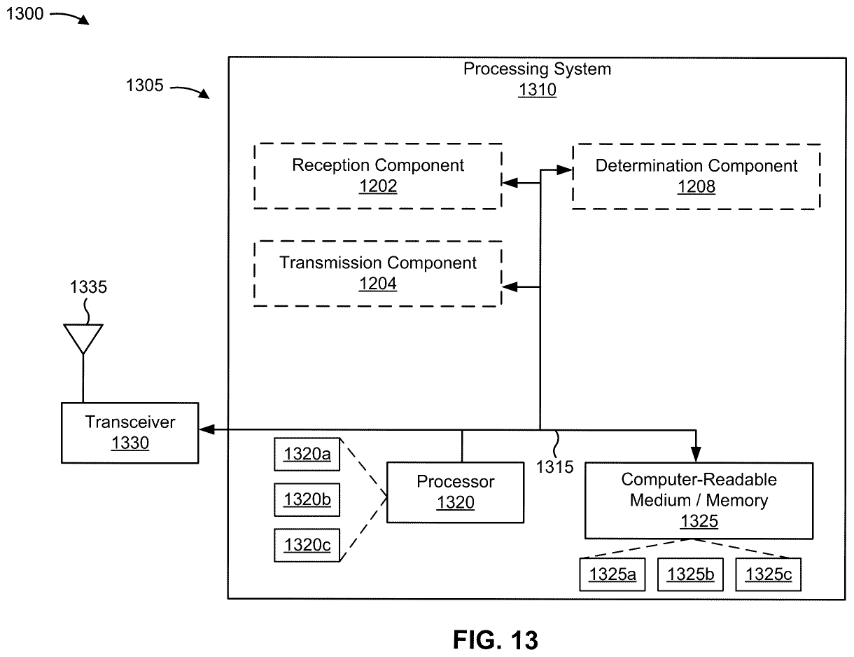

FIG. 13 is a diagram illustrating an example 1300 of a hardware implementation for an apparatus 1305 employing a processing system 1310. The apparatus 1305 may be a UE or may be at (e.g., included in) a UE. The processing system 1310 may be, or may be similar to, the processing system 140 of the UE 120 described in connection with FIG. 1.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors or hardware components, represented by the processor 1320 (or processing circuitry), the illustrated components, and the computer-readable medium/memory 1325 (or memory circuitry). The processor 1320 may include multiple processors, such as processor 1320a, processor 1320b, and processor 1320c. The memory 1325 may include multiple memories, such as memory 1325a, memory 1325b, and memory 1325c The bus 1315 may also link various other circuits, such as timing sources, peripherals, voltage regulators, or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 or may be, may include, or may be included in the processing system 140 of the UE 120 described in connection with FIG. 1. In some aspects, the apparatus 1305 for wireless communication includes means for receiving, from a network node, an SBFD configuration that configures one or more SBFD time intervals and one or more non-SBFD time intervals; means for receiving, from the network node, a downlink message in accordance with the SBFD configuration; and means for transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. The aforementioned means may be one or more of the aforementioned components of the apparatus 1200 or the processing system 1310 of the apparatus 1305 configured to perform the functions recited by the aforementioned means. As described elsewhere herein, the processing system 1310 may include one or more components of the processing system 140 of the UE 120 described in connection with FIG. 1. In one configuration, the aforementioned means may be the processing system 140 or one or more components of the processing system 140 configured to perform the functions or operations recited herein.

FIG. 13 is provided as an example. Other examples may differ from what is described in connection with FIG. 13.

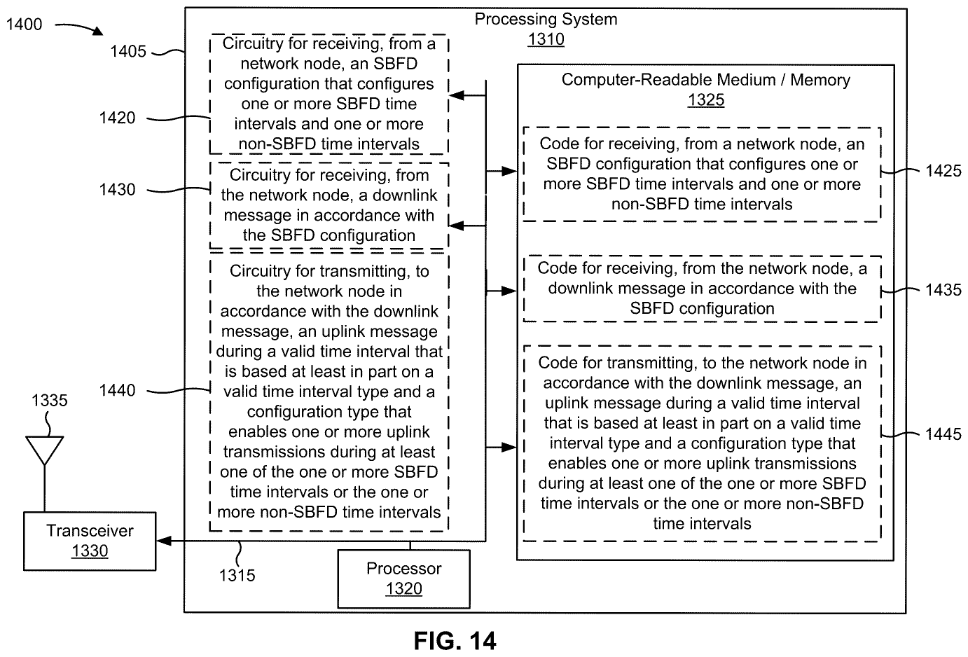

FIG. 14 is a diagram illustrating an example 1400 of an implementation of code and circuitry for an apparatus 1405. The apparatus 1405 may be a UE, or a UE may include the apparatus 1405.

As shown in FIG. 14, the apparatus 1405 may include circuitry for receiving, from a network node, an SBFD configuration that configures one or more SBFD time intervals and one or more non-SBFD time intervals (circuitry 1420). For example, the circuitry 1420 may enable the apparatus 1405 to receive, from a network node, an SBFD configuration that configures one or more SBFD time intervals and one or more non-SBFD time intervals.

As shown in FIG. 14, the apparatus 1405 may include, stored in computer-readable medium 1325, code for receiving, from a network node, an SBFD configuration that configures one or more SBFD time intervals and one or more non-SBFD time intervals (code 1425). For example, the code 1425, when executed by processor 1320, may cause processor 1320 to cause transceiver 1330 to receive, from a network node, an SBFD configuration that configures one or more SBFD time intervals and one or more non-SBFD time intervals.

As shown in FIG. 14, the apparatus 1405 may include circuitry for receiving, from the network node, a downlink message in accordance with the SBFD configuration (circuitry 1430). For example, the circuitry 1430 may enable the apparatus 1405 to receive, from the network node, a downlink message in accordance with the SBFD configuration.

As shown in FIG. 14, the apparatus 1405 may include, stored in computer-readable medium 1325, code for receiving, from the network node, a downlink message in accordance with the SBFD configuration (code 1435). For example, the code 1435, when executed by processor 1320, may cause processor 1320 to cause transceiver 1330 to receive, from the network node, a downlink message in accordance with the SBFD configuration.

As shown in FIG. 14, the apparatus 1405 may include circuitry for transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (circuitry 1440). For example, the circuitry 1440 may enable the apparatus 1405 to transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

As shown in FIG. 14, the apparatus 1405 may include, stored in computer-readable medium 1325, code for transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (code 1445). For example, the code 1445, when executed by processor 1320, may cause processor 1320 to cause transceiver 1330 to transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

FIG. 14 is provided as an example. Other examples may differ from what is described in connection with FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502 and a transmission component 1504, which may be in communication with one another (for example, via one or more buses or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 155. The communication manager 155 may include one or more of a send component 1508, or a obtain component 1510, among other examples. The communication manager 155 may be included in, or implemented via, a processing system (for example, the processing system 145 described in connection with FIG. 1) of the network node.

In some aspects, the apparatus 1500 may be configured to perform one or more operations described herein in connection with FIGS. 3 through 9. Additionally, or alternatively, the apparatus 1500 may be configured to perform one or more processes described herein, such as process 1100 of FIG. 11. In some aspects, the apparatus 1500 or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 or the transmission component 1504 may include or may be included in a network interface. The network interface may be configured to obtain or output signals for the apparatus 1500 via one or more communications links, such as a backhaul link, a midhaul link, or a fronthaul link.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The transmission component 1504 or the send component 1508 may send an SBFD configuration that configures one or more SBFD time intervals and one or more non-SBFD time intervals. The transmission component 1504 or the send component 1508 may send a downlink message in accordance with the SBFD configuration. The reception component 1502 or the obtain component 1510 may obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

The transmission component 1504 or the send component 1508 may send control signaling that indicates the valid time interval type for the uplink message.

The transmission component 1504 or the send component 1508 may send control information that activates a set of uplink messages that includes the uplink message and an initial uplink message that is transmitted before the uplink message, wherein the valid time interval type is equal to (e.g., the same as) a time interval type of a time interval associated with the initial uplink message.

The transmission component 1504 or the send component 1508 may send an indication of a time interval offset for transmission of the initial uplink message relative to transmission of an initial downlink message associated with the initial uplink message, wherein the time interval associated with the initial uplink message is based at least in part on the time interval offset.

The transmission component 1504 or the send component 1508 may send control information that activates a set of downlink messages that includes an initial downlink message and a set of uplink messages that includes the uplink message, wherein the valid time interval type is equivalent to (e.g., the same as) a time interval type of a time interval associated with the initial downlink message.

The transmission component 1504 or the send component 1508 may send configuration information that indicates the second configuration type.

The reception component 1502 or the obtain component 1510 may obtain the uplink message in accordance with the first configuration type based at least in part on the uplink message that is a feedback message.

The transmission component 1504 or the send component 1508 may send configuration information that indicates the configuration type is one of the first configuration type or the second configuration type.

The reception component 1502 or the obtain component 1510 may obtain the uplink message in accordance with the configuration indicated via the configuration information.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

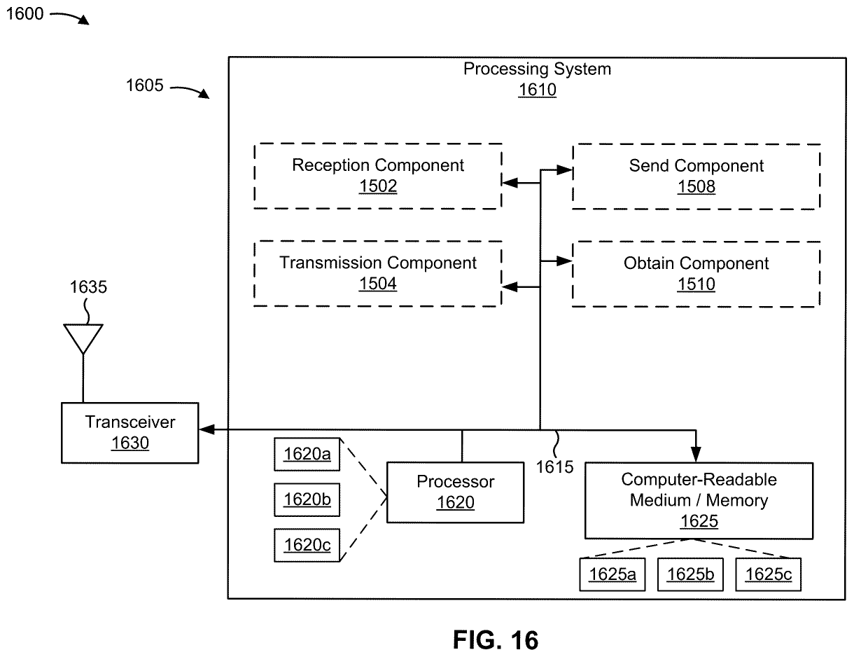

FIG. 16 is a diagram illustrating an example 1600 of a hardware implementation for an apparatus 1605 employing a processing system 1610. The apparatus 1605 may be a network node or may be at (e.g., included in) a network node. The processing system 1610 may be, or may be similar to, the processing system 145 of the network node 110 described in connection with FIG. 1.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors or hardware components, represented by the processor 1620 (or processing circuitry), the illustrated components, and the computer-readable medium/memory 1625 (or memory circuitry). The processor 1620 may include multiple processors, such as processor 1620a, processor 1620b, and processor 1620c. The memory 1625 may include multiple memories, such as memory 1625a, memory 1625b, and memory 1625c The bus 1615 may also link various other circuits, such as timing sources, peripherals, voltage regulators, or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the network node 110 or may be, may include, or may be included in the processing system 145 of the network node 110 described in connection with FIG. 1. In some aspects, the apparatus 1605 for wireless communication includes means for means for sending an SBFD configuration that configures one or more SBFD time intervals and one or more non-SBFD time intervals; means for sending a downlink message in accordance with the SBFD configuration; and means for obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals. The aforementioned means may be one or more of the aforementioned components of the apparatus 1500 or the processing system 1610 of the apparatus 1605 configured to perform the functions recited by the aforementioned means. As described elsewhere herein, the processing system 1610 may include one or more components of the processing system 145. In one configuration, the aforementioned means may be processing system 145 or one or more components of the processing system 145 configured to perform the functions or operations recited herein.

FIG. 16 is provided as an example. Other examples may differ from what is described in connection with FIG. 16.

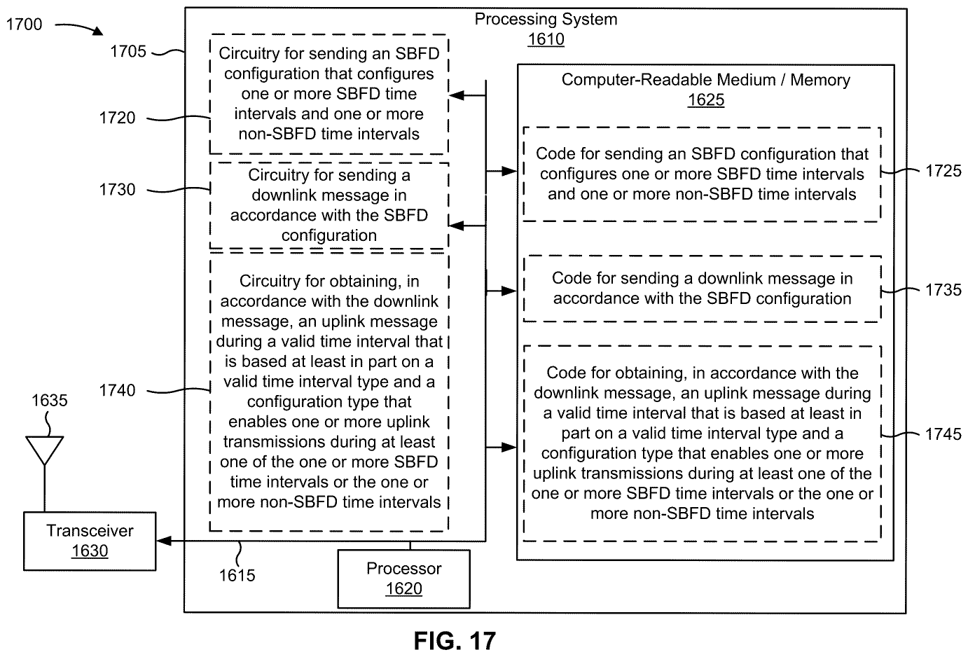

FIG. 17 is a diagram illustrating an example 1700 of an implementation of code and circuitry for an apparatus 1705. The apparatus 1705 may be a network node, or a network node may include the apparatus 1705.

As shown in FIG. 17, the apparatus 1705 may include circuitry for sending an SBFD configuration that configures one or more SBFD time intervals and one or more non-SBFD time intervals (circuitry 1720). For example, the circuitry 1720 may enable the apparatus 1705 to send an SBFD configuration that configures one or more SBFD time intervals and one or more non-SBFD time intervals.

As shown in FIG. 17, the apparatus 1705 may include, stored in computer-readable medium 1625, code for sending an SBFD configuration that configures one or more SBFD time intervals and one or more non-SBFD time intervals (code 1725). For example, the code 1725, when executed by processor 1620, may cause processor 1620 to send an SBFD configuration that configures one or more SBFD time intervals and one or more non-SBFD time intervals.

As shown in FIG. 17, the apparatus 1705 may include circuitry for sending a downlink message in accordance with the SBFD configuration (circuitry 1730). For example, the circuitry 1730 may enable the apparatus 1705 to send a downlink message in accordance with the SBFD configuration.

As shown in FIG. 17, the apparatus 1705 may include, stored in computer-readable medium 1625, code for sending a downlink message in accordance with the SBFD configuration (code 1735). For example, the code 1735, when executed by processor 1620, may cause processor 1620 to send a downlink message in accordance with the SBFD configuration.

As shown in FIG. 17, the apparatus 1705 may include circuitry for obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (circuitry 1740). For example, the circuitry 1740 may enable the apparatus 1705 to obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

As shown in FIG. 17, the apparatus 1705 may include, stored in computer-readable medium 1625, code for obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals (code 1745). For example, the code 1745, when executed by processor 1620, may cause processor 1620 to obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

FIG. 17 is provided as an example. Other examples may differ from what is described in connection with FIG. 17.

The following provides an overview of some Aspects of the present disclosure:
Aspect 1: A method of wireless communication performed by a user equipment (UE), comprising: receiving, from a network node, a subband full-duplex (SBFD) configuration that configures one or more SBFD time intervals and one or more non-SBFD time intervals; receiving, from the network node, a downlink message in accordance with the SBFD configuration; and transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.
Aspect 2: The method of Aspect 1, further comprising: receiving, from the network node, control signaling that indicates the valid time interval type for the uplink message.
Aspect 3: The method of any of Aspects 1-2, further comprising: receiving, from the network node, control information that activates a set of uplink messages that includes the uplink message and an initial uplink message that is transmitted before the uplink message, wherein the valid time interval type is equal to (e.g., the same as) a time interval type of a time interval associated with the initial uplink message.
Aspect 4: The method of Aspect 3, further comprising: receiving, from the network node, an indication of a time interval offset for transmission of the initial uplink message relative to transmission of an initial downlink message associated with the initial uplink message, wherein the time interval associated with the initial uplink message is based at least in part on the time interval offset.
Aspect 5: The method of any of Aspects 1-4, further comprising: receiving, from the network node, control information that activates a set of downlink messages that includes an initial downlink message and a set of uplink messages that includes the uplink message, wherein the valid time interval type is equivalent to (e.g., the same as) a time interval type of a time interval associated with the initial downlink message.
Aspect 6: The method of any of Aspects 1-5, wherein: the configuration type enables the one or more uplink transmissions during one of the one or more SBFD time intervals or the one or more non-SBFD time intervals, the valid time interval type is an SBFD-type, the valid time interval is a next available SBFD time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 7: The method of any of Aspects 1-6, wherein: the configuration type enables the one or more uplink transmissions during one of the one or more non-SBFD time intervals or the one or more SBFD time intervals, the valid time interval type is a non-SBFD-type, the valid time interval is a next available uplink or flexible time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 8: The method of any of Aspects 1-7, wherein: the configuration type enables the one or more uplink transmissions during both the one or more non-SBFD time intervals and the one or more SBFD time intervals, the valid time interval is a next available uplink, flexible, or SBFD time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 9: The method of any of Aspects 1-8, wherein the configuration type enables the one or more uplink transmissions during both the one or more non-SBFD time intervals and the one or more SBFD time intervals and the uplink message is associated with a single set of frequency resources.
Aspect 10: The method of Aspect 9, wherein the one or more SBFD time intervals are one or more invalid time intervals.
Aspect 11: The method of Aspect 9, wherein an SBFD time interval of the one or more SBFD time intervals, that includes an uplink subband outside of the single set of frequency resources, is an invalid time interval.
Aspect 12: The method of Aspect 9, wherein an SBFD time interval of the one or more SBFD time intervals, that includes one or more first symbols that at least partially overlap with one or more second symbols of the uplink message and are associated with a synchronization signal block (SSB) or associated with a control resource set (CORESET) used for a Type-0 common search space (CSS), is an invalid time interval.
Aspect 13: The method of any of Aspects 1-12, wherein a first configuration type enables the one or more uplink transmissions during one of the one or more SBFD time intervals or the one or more non-SBFD time intervals, and a second configuration type enables the one or more uplink transmissions during both of the one or more SBFD time intervals and the one or more non-SBFD time intervals.
Aspect 14: The method of Aspect 13, further comprising: receiving, from the network node, configuration information that indicates the second configuration type; and transmitting, to the network node, the uplink message in accordance with the first configuration type based at least in part on the uplink message that is a feedback message.
Aspect 15: The method of Aspect 13, further comprising: receiving, from the network node, configuration information that indicates the configuration type is one of the first configuration type or the second configuration type; and transmitting, to the network node, the uplink message in accordance with the configuration indicated via the configuration information.
Aspect 16: A method of wireless communication performed by a network node, comprising: sending a subband full-duplex (SBFD) configuration that configures one or more SBFD time intervals and one or more non-SBFD time intervals; sending a downlink message in accordance with the SBFD configuration; and obtaining, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.
Aspect 17: The method of Aspect 16, further comprising: sending control signaling that indicates the valid time interval type for the uplink message.
Aspect 18: The method of any of Aspects 16-17, further comprising: sending control information that activates a set of uplink messages that includes the uplink message and an initial uplink message that is transmitted before the uplink message, wherein the valid time interval type is equal to (e.g., the same as) a time interval type of a time interval associated with the initial uplink message.
Aspect 19: The method of Aspect 18, further comprising: sending an indication of a time interval offset for transmission of the initial uplink message relative to transmission of an initial downlink message associated with the initial uplink message, wherein the time interval associated with the initial uplink message is based at least in part on the time interval offset.
Aspect 20: The method of any of Aspects 16-19, further comprising: sending control information that activates a set of downlink messages that includes an initial downlink message and a set of uplink messages that includes the uplink message, wherein the valid time interval type is equivalent to (e.g., the same as) a time interval type of a time interval associated with the initial downlink message.
Aspect 21: The method of any of Aspects 16-20, wherein: the configuration type enables the one or more uplink transmissions during one of the one or more SBFD time intervals or the one or more non-SBFD time intervals, the valid time interval type is an SBFD-type, the valid time interval is a next available SBFD time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 22: The method of any of Aspects 16-21, wherein: the configuration type enables the one or more uplink transmissions during one of the one or more non-SBFD time intervals or the one or more SBFD time intervals, the valid time interval type is a non-SBFD-type, the valid time interval is a next available uplink or flexible time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 23: The method of any of Aspects 16-22, wherein: the configuration type enables the one or more uplink transmissions during both the one or more non-SBFD time intervals and the one or more SBFD time intervals, the valid time interval is a next available uplink, flexible, or SBFD time interval after a time interval associated with the downlink message, and one or more first symbols of the uplink message are different than one or more second symbols that are associated with a synchronization signal block (SSB) or associated with a control resource set (CORESET) used for a Type-0 common search space (CSS).
Aspect 24: The method of any of Aspects 16-23, wherein the configuration type enables the one or more uplink transmissions during both the one or more non-SBFD time intervals and the one or more SBFD time intervals and the uplink message is associated with a single set of frequency resources.
Aspect 25: The method of Aspect 24, wherein the one or more SBFD time intervals are one or more invalid time intervals.
Aspect 26: The method of Aspect 24, wherein an SBFD time interval of the one or more SBFD time intervals, that includes an uplink subband outside of the single set of frequency resources, is an invalid time interval.
Aspect 27: The method of Aspect 24, wherein an SBFD time interval of the one or more SBFD time intervals, that includes one or more first symbols that at least partially overlap with one or more second symbols of the uplink message and are associated with a synchronization signal block (SSB) or associated with a control resource set (CORESET) used for a Type-0 common search space (CSS), is an invalid time interval.
Aspect 28: The method of any of Aspects 16-27, wherein a first configuration type enables the one or more uplink transmissions during one of the one or more SBFD time intervals or the one or more non-SBFD time intervals, and a second configuration type enables the one or more uplink transmissions during both of the one or more SBFD time intervals and the one or more non-SBFD time intervals.
Aspect 29: The method of Aspect 28, further comprising: sending configuration information that indicates the second configuration type; and obtaining the uplink message in accordance with the first configuration type based at least in part on the uplink message that is a feedback message.
Aspect 30: The method of Aspect 28, further comprising: sending configuration information that indicates the configuration type is one of the first configuration type or the second configuration type; and obtaining the uplink message in accordance with the configuration indicated via the configuration information.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a subband full-duplex (SBFD) configuration that configures one or more SBFD time intervals and one or more non-SBFD time intervals;
receive, from the network node, a downlink message in accordance with the SBFD configuration; and
transmit, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

2. The UE of claim 1, wherein the one or more processors are further configured to cause the UE to:
receive, from the network node, control signaling that indicates the valid time interval type for the uplink message.

3. The UE of claim 1, wherein the one or more processors are further configured to cause the UE to:
receive, from the network node, control information that activates a set of uplink messages that includes the uplink message and an initial uplink message that is transmitted before the uplink message, wherein the valid time interval type is equal to a time interval type of a time interval associated with the initial uplink message.

4. The UE of claim 3, wherein the one or more processors are further configured to cause the UE to:
receive, from the network node, an indication of a time interval offset for transmission of the initial uplink message relative to transmission of an initial downlink message associated with the initial uplink message, wherein the time interval associated with the initial uplink message is based at least in part on the time interval offset.

5. The UE of claim 1, wherein the one or more processors are further configured to cause the UE to:
receive, from the network node, control information that activates a set of downlink messages that includes an initial downlink message and a set of uplink messages that includes the uplink message, wherein the valid time interval type is equivalent to a time interval type of a time interval associated with the initial downlink message.

6. The UE of claim 1, wherein:
the configuration type enables the one or more uplink transmissions during one of the one or more SBFD time intervals or the one or more non-SBFD time intervals,
the valid time interval type is an SBFD-type,
the valid time interval is a next available SBFD time interval after a time interval associated with the downlink message, and
one or more first symbols of the uplink message are different than one or more second symbols that are associated with a synchronization signal block (SSB) or associated with a control resource set (CORESET) used for a Type-0 common search space (CSS).

7. The UE of claim 1, wherein:
the configuration type enables uplink transmissions during one of the one or more non-SBFD time intervals or the one or more SBFD time intervals,
the valid time interval type is a non-SBFD-type,
the valid time interval is a next available uplink or flexible time interval after a time interval associated with the downlink message, and
one or more first symbols of the uplink message are different than one or more second symbols that are associated with a synchronization signal block (SSB) or associated with a control resource set (CORESET) used for a Type-0 common search space (CSS).

8. The UE of claim 1, wherein:
the configuration type enables the one or more uplink transmissions during both the one or more non-SBFD time intervals and the one or more SBFD time intervals,
the valid time interval is a next available uplink, flexible, or SBFD time interval after a time interval associated with the downlink message, and
one or more first symbols of the uplink message are different than one or more second symbols that are associated with a synchronization signal block (SSB) or associated with a control resource set (CORESET) used for a Type-0 common search space (CSS).

9. The UE of claim 1, wherein the configuration type enables the one or more uplink transmissions during both the one or more non-SBFD time intervals and the one or more SBFD time intervals and the uplink message is associated with a single set of frequency resources.

10. The UE of claim 9, wherein the one or more SBFD time intervals are one or more invalid time intervals.

11. The UE of claim 9, wherein an SBFD time interval of the one or more SBFD time intervals, that includes an uplink subband outside of the single set of frequency resources, is an invalid time interval.

12. The UE of claim 9, wherein an SBFD time interval of the one or more SBFD time intervals, that includes one or more first symbols that at least partially overlap with one or more second symbols of the uplink message and are associated with a synchronization signal block (SSB) or associated with a control resource set (CORESET) used for a Type-0 common search space (CSS), is an invalid time interval.

13. The UE of claim 1, wherein a first configuration type enables the one or more uplink transmissions during one of the one or more SBFD time intervals or the one or more non-SBFD time intervals, and a second configuration type enables the one or more uplink transmissions during both of the one or more SBFD time intervals and the one or more non-SBFD time intervals.

14. The UE of claim 13, wherein the one or more processors are further configured to cause the UE to:
receive, from the network node, configuration information that indicates the second configuration type; and
transmit, to the network node, the uplink message in accordance with the first configuration type based at least in part on the uplink message that is a feedback message.

15. The UE of claim 13, wherein the one or more processors are further configured to cause the UE to:
receive, from the network node, configuration information that indicates the configuration type is one of the first configuration type or the second configuration type; and
transmit, to the network node, the uplink message in accordance with the configuration indicated via the configuration information.

16. A network node for wireless communication, comprising:
one or more memories; and
one or more processors, coupled to the one or more memories, configured to cause the network node to:
send a subband full-duplex (SBFD) configuration that configures one or more SBFD time intervals and one or more non-SBFD time intervals;
send a downlink message in accordance with the SBFD configuration; and
obtain, in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.

17. The network node of claim 16, wherein the one or more processors are further configured to cause the network node to:
send control signaling that indicates the valid time interval type for the uplink message.

18. The network node of claim 16, wherein the one or more processors are further configured to cause the network node to:
send control information that activates a set of uplink messages that includes the uplink message and an initial uplink message that is transmitted before the uplink message,
wherein the valid time interval type is equal to a time interval type of a time interval associated with the initial uplink message.

19. The network node of claim 18, wherein the one or more processors are further configured to cause the network node to:
send an indication of a time interval offset for transmission of the initial uplink message relative to transmission of an initial downlink message associated with the initial uplink message, wherein the time interval associated with the initial uplink message is based at least in part on the time interval offset.

20. A method of wireless communication performed by a user equipment (UE), comprising:
receiving, from a network node, a subband full-duplex (SBFD) configuration that configures one or more SBFD time intervals and one or more non-SBFD time intervals;
receiving, from the network node, a downlink message in accordance with the SBFD configuration; and
transmitting, to the network node in accordance with the downlink message, an uplink message during a valid time interval that is based at least in part on a valid time interval type and a configuration type that enables one or more uplink transmissions during at least one of the one or more SBFD time intervals or the one or more non-SBFD time intervals.
